(19) United States
(12) Patent Application Publication
(10) Pub. No.: US 2005/0187806 A1
(43) Pub. Date: Aug. 25, 2005

(54) Global animation studio

(75) Inventors: Gary I. Wurtzel, Passaic, NJ (US); Yitzchak Wurtzel, Far Rockaway, NY (US); Eliyahu Wurtzel, Ramat Beit Shemesh (IL)

Correspondence Address: OBLON, SPIVAK, MCCLELLAND, MAIER & NEUSTADT, P.C., 1940 DUKE STREET, ALEXANDRIA, VA, 22314, US

(73) Assignee: IDT Corporation, Newark, NJ (US)

(21) Appl. No.: 10/781,785

(22) Filed: Feb. 20, 2004

(51) Int. Cl. G06F 17/60

(52) U.S. Cl. 705/9

(57) ABSTRACT

A global animation system includes: a pool of reusable characteristics for at least one character or feature; and a pool of available artists, wherein a member of the pool of available artists selects at least one reusable characteristic from the pool of reusable characteristics to create a character or feature. A method for managing an animation project includes: obtaining an animation project; disassembling the animation project into at least one individual task; assigning the at least one individual task to an artist, wherein the artist completes the at least one individual task using at least one characteristic stored in a pool of reusable characteristics.

### BACKGROUND OF THE INVENTION

1. Field of the Invention

This invention relates generally to coordinating global animation resources using the internet. Specifically, this invention relates to assigning and managing resources for use with animation projects.

2. Discussion of the Background

The evolution of computer hardware and animation software has resulted in the placement of significant animation production with small businesses around the world. Some software packages have established the standards for components of animation, including wire frames, three dimensional (3D) visual objects, object rigging (describing dynamic behavior), and file formats.

Through the use of the internet, it is now possible for international businesses to produce affordable animation for American movie production companies. However, it has not yet been possible to manage price/production value tradeoffs while coordinating and controlling global production resources. Additionally, national and treaty laws often govern the fraction of locally produced content that must be included in media distributed within individual countries.

### SUMMARY OF THE INVENTION

Accordingly, in light of the foregoing difficulties, the present invention, the Global Animation Studio (GAS) has been developed to provide an opportunity for global animation resources to compete for contracts with large scale production companies.

A first non-limiting aspect of the invention provides a global animation system including: a pool of reusable characteristics for at least one character; and a pool of available artists, wherein a member of the pool of available artists selects at least one reusable characteristic from the pool of reusable characteristics.

A second non-limiting aspect includes a method for managing an animation project, including: obtaining an animation project; disassembling the animation project into at least one individual task; assigning the at least one individual task to an artist, wherein the artist completes the at least one individual task using at least one characteristic stored in a pool of reusable characteristics.

Another aspect of the present invention provides a method for searching for reusable characteristics, including: searching a pool of reusable characteristics for at least one first characteristic; identifying at least one second characteristic related to the at least one first characteristic; notifying a user of the at least one second characteristic; locating a file containing the at least one second characteristic; and providing the file.

Another aspect of the present invention provides a system for searching for reusable characteristics, including: means for searching a pool of reusable characteristics for at least one first characteristic; means for identifying at least one second characteristic related to the at least one first characteristic; means for notifying a user of the at least one second characteristic; means for locating a file containing the at least one second characteristic; and means for providing the file.

### BRIEF DESCRIPTION OF THE DRAWINGS

FIG. 1 illustrates an access page for the global animation studio;

FIGS. 2-4 illustrate the plug-in detection wizard of the global animation systems;

FIG. 5 illustrates a list of viewable projects;

FIG. 6 illustrates image files for a selected project;

FIGS. 7A and 7B illustrate the images of FIG. 5;

FIGS. 8A and 8B illustrate a user's ability to modify personal information;

FIG. 9 illustrates a user password request screen;

FIG. 10 illustrates the studio mogul aspect of the web mogul;

FIGS. 11A and 11B illustrate the user manager;

FIG. 12 illustrates a create a new user screen;

FIGS. 13A-13C illustrate searchability features;

FIG. 14 illustrates a group manager;

FIG. 15 illustrates creating a new user group;

FIG. 16 illustrates the invoice manager;

FIG. 17A-17D illustrate user details accessible by administrators;

FIG. 18 illustrates the project manager;

FIGS. 19A, 19B, and 20 are “heads up” summaries of a given production;

FIGS. 21 and 22 illustrate the production scheduler;

FIGS. 23-27 represent snapshot information for a project;

FIG. 28 is a non-limiting view of the tasks calendar;

FIG. 29 illustrates the production manager;

FIG. 30 illustrates the production bin;

FIG. 31 illustrates the project bin folder manager;

FIG. 32 depicts the production group of the production manager;

FIG. 33 illustrates an add or delete user screen;

FIG. 35 depicts the screening room manager;

FIG. 36 illustrates the screening room details for a particular project;

FIGS. 37 and 38 show the screening room file manager;

FIG. 39 illustrates a screening room folder manager;

FIG. 40 shows security features;

FIG. 41 illustrates the screening room settings;

FIG. 42 illustrates a screening room logo and client information;

FIGS. 43A and 43B illustrates a messaging feature;

FIG. 44A and FIG. 44B represent the messaging-fax center;

FIG. 45A-45C illustrate the recording features;

FIGS. 46A and 46B illustrate a sample report;

FIGS. 47A and 47B illustrate a created custom system report;

FIG. 48 illustrates an example workload report;

FIG. 49 shows a job report;

FIG. 50 illustrates a report of talent waiting to be reviewed;

FIG. 51 illustrates the project pricing report;

FIG. 52 illustrates a production list;

FIG. 53 is an example of a job messaging report;

FIG. 54 illustrates more details of the job report of FIG. 53;

FIG. 55 shows the screening room messages report;

FIG. 56 illustrates a new production information report;

FIG. 57 illustrates a custom task being created;

FIG. 58 represents the job manager;

FIGS. 59A-59D illustrate the searchability of the GAS;

FIG. 60 illustrates security settings;

FIGS. 61A-61D illustrate the setup for each user;

FIG. 62 illustrates preferences set by an administrator;

FIGS. 63A and 63B illustrate an overview of the studio mogul architecture and work flow;

FIG. 64 illustrates the login screen for the studio mogul;

FIG. 65 depicts information for each employee;

FIG. 66 illustrates an asset manager;

FIG. 67 illustrates the accessing of a project;

FIG. 68 illustrates items that have been created for a project;

FIG. 69 illustrates the add a new user wizard of the studio mogul;

FIGS. 69A-69F illustrate features of the studio mogul that may be initiated for a new user;

FIG. 70 illustrates additional information for a user;

FIG. 71 illustrates a skill set information entry screen;

FIG. 72 illustrates available skill sets;

FIG. 73 illustrates a rating screen;

FIG. 74 illustrates a successful entry screen;

FIG. 75 illustrates a setup screen for a new project;

FIG. 76 illustrates phase 2 of the new project wizard;

FIG. 77 represents phase 3 of the new project wizard;

FIG. 78 illustrates the new user name and password creation screen;

FIG. 79 illustrates a screen to create a file and file notes;

FIG. 80 illustrates a work site login;

FIG. 81 illustrates a password recovery screen;

FIG. 82 illustrates a wizard detection system;

FIG. 83 illustrates a successful detection;

FIG. 84 illustrates a GAS home page;

FIG. 85 illustrates the job view;

FIG. 86 illustrates bin details;

FIG. 87 illustrates available resources;

FIG. 88 illustrates message accessing and modification;

FIG. 89 illustrates the create a new message feature;

FIG. 90 shows previously sent messages;

FIG. 91 illustrates a user upload screen;

FIG. 92 illustrates a download screen;

FIG. 93 illustrates a user profile editing screen;

FIG. 94 illustrates an overview of an animation project;

FIG. 95 illustrates pre-production;

FIG. 96 illustrates concept design and development;

FIG. 97 depicts an animatic;

FIG. 98 shows production;

FIG. 99 illustrates post-production; and

FIG. 100 illustrates a sample storyboard.

### DESCRIPTION OF THE EMBODIMENTS

Overview of the GAS

GAS is an infinitely scalable array of animation shops and independent artists networked together through a series of protocols to act, in effect, as a single united studio. There are three conceptual layers to the network. The A level includes network hubs that are wholly owned and operated. The B level includes shops that are independently owned, but act as network hubs on a fairly long-term basis, as needed. The C level shops are independent artists who have requested to be affiliated with the GAS, and who have previously been approved and reviewed by the GAS staff.

This three-tiered architecture has several advantages. Producing work entirely in-house is too expensive for moderately budgeted animation feature and TV series work. Broadcast companies today simply cannot support entirely in-house productions without seriously compromising character animation, effects, and overall quality. On the other hand, the outsourcing option almost always involves a tradeoff in which managerial, fiscal, and aesthetic controls are sacrificed in favor of lower costs.

The present invention overcomes these difficulties. According to the GAS, each project is broken down into digital objects, each object being allocated to the production site most appropriate for it. A job on a given digital object may go to a particular shop for several reasons. These reasons may include (1) a studio's proven skill sets, (2) a studio's track record for a similar kind of task, (3) the studio's ability to perform within a particular time frame, (4) the qualifications of the studio or artist in terms of various international production treaties and/or eligibility for tax rebates or other economic factors, and (5) the affinity of a producer, director, or client for a given studio or individual artist.

Security may also be a strong consideration in the assignment of a particular job. Specifically, digital objects having special value are generally assigned to level A and level B shops to prevent accidental disclosure, theft, or other security violations.

Additionally, by breaking down a project into individual digital objects, it is possible to pay the absolute minimum cost for a project by paying an appropriate price for each task. For example, it is possible to incorporate high-level talent and higher prices where the value for high-level talent may be appreciated. By contrast, in a conventional outsourcing scenario, the least talented member of a studio's team may charge a high price for a given task, while the best talent in the same studio may be unsatisfactory for the requirements for an individual character or storytelling item.

The final product produced by the GAS is seamless, because all lighting, compositing, and rendering are done in one of the wholly owned hubs.

GAS also enables scalability. By using a high volume number of studios and independent artists who acquire affiliate status and who are available on a standby basis, it is possible to use the asset management, job tickets, and job tracking of the GAS to scale projects.

Overview of the Production Cycle

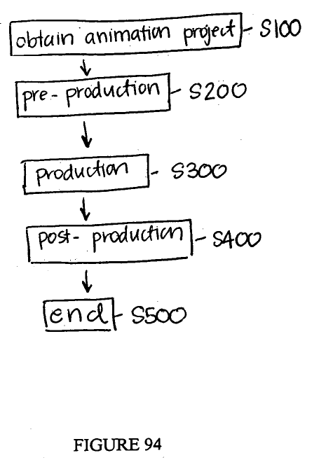

In the making of an animation feature film, the process is generally broken down into three phases. These three phases include: pre-production, production, and post-production, as illustrated in FIG. 94.

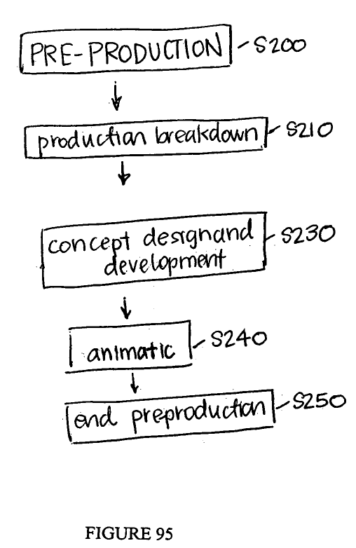

The first phase, referred to as pre-production, entails a production breakdown. During production breakdown, the characters and assets (i.e., scenes, objects, and other items necessary to produce the animation) are identified. Pre-production is illustrated in FIG. 95.

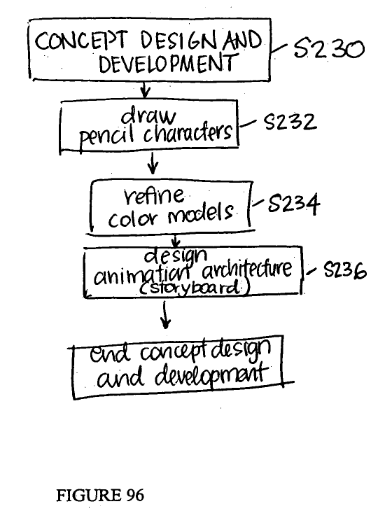

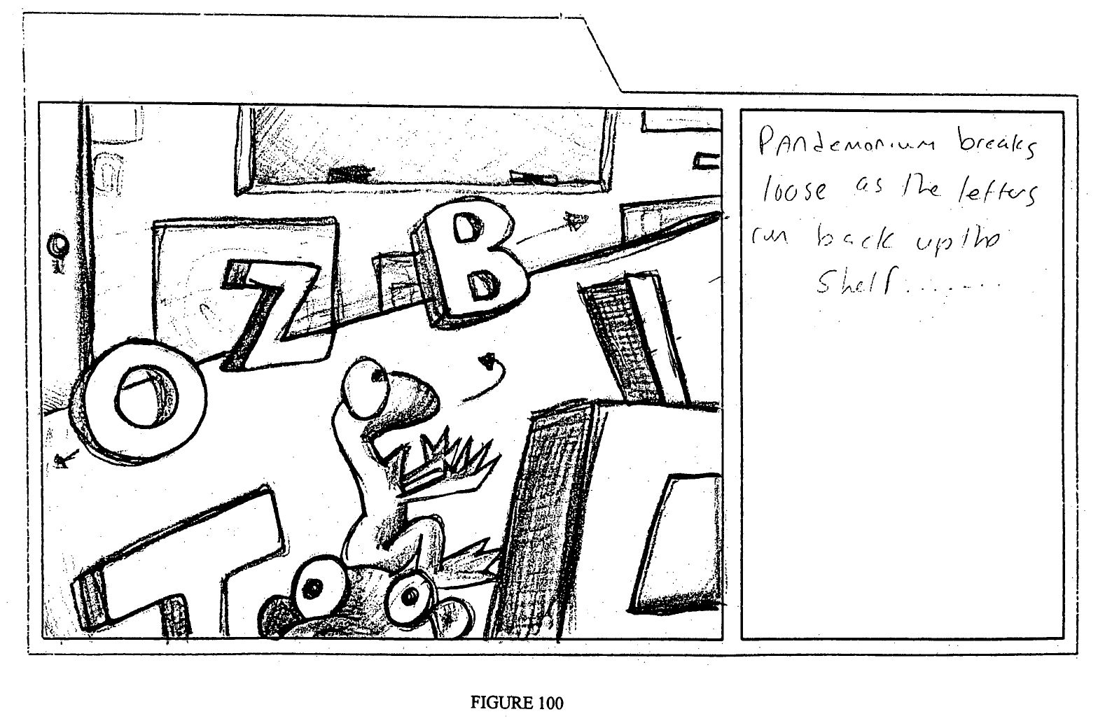

The second step of pre-production is concept design and development, which is illustrated in FIG. 96. In this portion of the pre-production phase, artists design characters, generally as pencil drawings which are refined into color models, either automatically or by hand in steps S232 and S234. This phase represents one of the most creative phases in an animation production. It is during the design of the characters that the personalities of the characters are identified, their appearance/look is specified, and their emotions and behaviors are identified. The architecture of the animation is also designed at this time in step S236. A sample storyboard is illustrated in FIG. 100. As shown in FIG. 100, the storyboard includes a scene, which may include a character. Commentary about the actions or events to occur in the scene may be included in the designated area.

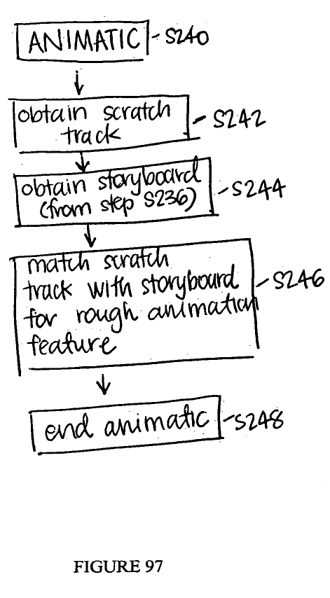

When the design and the storyboards are complete, an animatic is generated (FIG. 97). The animatic is usually digital, and includes an audio track (obtained in step S242) with dialog (i.e., the scratch track) matched to the storyboard image in step S246. Each frame of the storyboard is played along with the scratch track in continuous form.

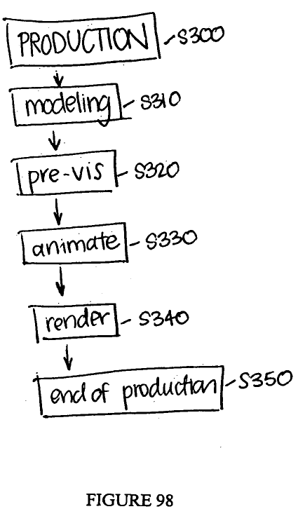

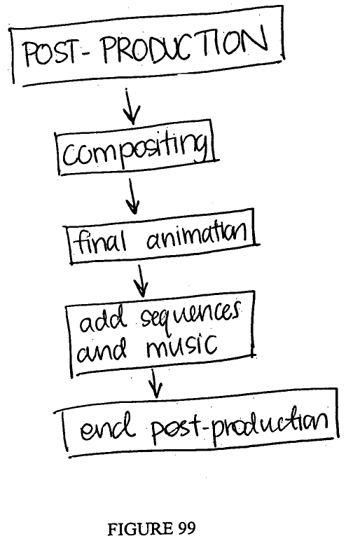

The animatic process begins the transition into the production phase. In the production phase, illustrated in FIG. 98, there is much more limited decentralization. The production phase is generally the longest phase of an animation project, and it is in the production phase that some of the greatest efficiencies may be achieved. The first part of production is modeling (step S310). Modeling is followed by a pre-vis in step S320, which is a 3D version of the animatic.

Once the animatic and pre-vis are completed, animation begins in step S320. Animation represents the longest segment of production. After the animation phase, the materials are rendered in step S340. Rendering is very time expensive. Generally, 400 to 500 computers run 24 hours/seven days a week to complete staggered production in a rendering farm. During rendering, points of light are traced through the scene in what is called ray tracing. Ray tracing enables the lighting to be consistent throughout the scene, so that shadows and other light indicators are properly positioned.

The post-production process includes compositing final animation, and sequences in music. Compositing includes color correction and final editing.

The following non-limiting embodiment of the present invention will be described for a single project from inception to completion. However, the GAS is capable of accommodating multiple concurrent projects. The GAS process includes four major stages: priming the process, soliciting projects, managing projects, and adapting the process.

Priming the Process

The first step, priming the process, includes the actions required to create a relationship between the GAS, the artists, and remote affiliated studios. Applicant animation artists access a website hosted on the web servers of the GAS that is designed to recruit, test, and classify the expertise of each applicant artist. Portfolio samples are classified by the GAS staff according to specialty. Specialties may include, for example, morphing, wire frame modeling, and texturing. The GAS staff also grades the portfolios, for example, on a scale of 1-10.

The animation artist's performance rating in the talent database may be updated to reflect an average of results over time. These averages may be calculated by the production staff, such as the supervisor, production manager, and producer. The criteria used to determine the artists' performance include responsiveness, quality of work, quota fulfillment, and timeliness. Other factors may also be considered, as would be apparent to those of skill in the art.

Once the rating is complete, a member of the GAS staff then enters the results of the application process, as well as details related to the contractual relationship with each artist in the talent database.

The GAS administration enters the results of the application process, as well as details related to the contractual relationship with each artist into the talent database. Animation studios may also apply in a similar manner to establish a relationship with the GAS. Animation studios may be facility based, and may also be licensed by the GAS to employ a similar architecture and operations. The databases of the present invention may include RDBMS relational databases (e.g., SQL servers), ODBL, and OLE-based databases, as non-limiting examples.

The GAS also employs in-house artists to provide quick turnaround of jobs, as needed. The GAS uses the in-house artists to rate remote animation artists, as well as to integrate completed jobs into the finished product.

Priming the process also includes the initial selection of animation software packages for use by all of the artists, both local and remote. For example, the GAS may employ Discrete's 3D-Studio Max and Soft Image, or other programs apparent to those of skill in the art. The selected software packages will populate the standard software database. Artists who establish a relationship with the GAS must use the standard packages, which may be provided through the GAS as part of the contractual relationship.

Soliciting Projects

Soliciting projects relates to marketing to obtain animation projects. The production of animation projects involves a variety of roles, including investors, sponsors, funding sources, producers, directors, script writers, rights owners, as well as others. Each project is assumed to have a GAS projects customer, which represents the people and companies guiding the production of the animation project.

All information about a project, including scripts, context, and contracts, is entered by GAS administration. The project information is input into the project database. The GAS generally assumes that an accepted animation project includes at least a script, but a script could be subsequently created. A storyboard and 2D rough sketches of the characters may also be included.

Managing Animation Projects

Managing animation projects includes manually creating the storyboard using the script. Scriptwriting software (e.g., Word or Final-Draft Pro) may be used to create the script. Based on the complexity of the storyboard, a project plan is prepared including a schedule and budget. Additionally, assignable jobs are created by the producer, production manager, or other GAS personnel. Each job may consist of one or more objects, or of certain portions of objects, such as wire frames. Job descriptions generally include the minimum amount of information (meta-data) necessary for an artist to express creativity while ensuring that the resulting job may be seamlessly integrated into the completed animated film. Often, the information includes important elements such as objects, rigging, wire frames, scenes, color palettes, and voiced script parts.

Rigging requirements may be obtained through creative concepts, which may be based on a character's range of motion and activities to be performed, and the use of motion-capture studio, which may constitute an integral part of the GAS.

In the motion capture studio, actors or dancers wear a plurality of sensors on their bodies while dancing or moving as the character would move. This data is captured through the sensors, and applied to the animation characters themselves. Through this technology, it is possible to obtain a more lifelike movement of the animated characters. Rigging information may be refined based on creative concepts, as well as on the motion-capture equipment.

The objects database and external object markets are searched for viable objects or object components satisfying the requirements of the projects. Any OLE/ODBC compliant database, for middle tier COM/COMT objects, and VisualBasic for front end objects, are examples of technologies that may be used for searching. The GAS is platform agnostic (e.g., the GAS works with Oracle and C++, as non-limiting examples).

External object sources include, for example, ViewPoint, 3D Cafe, 3D Site, and 3D objects market such as 3D Model Works. The decision whether or not to use an object or another component, such as texture, available from an external source may be based on factors such as the object's usefulness for the project's requirements, its quality, its digital rights, and its price. This decision may be made by (for example) GAS personnel, legal personnel, or a cost benefit analyst.

Management further includes assigning any remaining jobs to in-house artists and external studios or animation artists. These assignment decisions are based on factors such as the artists' availability, skill sets, and expected quality as obtained in the talent database. Other factors that may be useful for the assignment of remaining jobs include nationality, physical location, as well as national and international treaty constraints. The artists may accept or decline assignments and schedules. The GAS staff ratifies each assignment and assigned contract, and inserts the details of the assignments into the projects database and the talent database.

For management purposes, artists' projects may be tracked using daily updates uploaded to the GAS facilities by each artist. These are loaded through an artist interface, as illustrated in the figures. These “dailies” are stored in the project snapshot database, and are visible to the appropriate GAS administration staff. The members of the GAS administration who have access to each file is determined by production management staff, such as the producer, producing manager, and the line producer or other appropriate manager.

The GAS staff provides guidance and feedback to the artists, and may authorize partial or full payment for projects, based on the artists' contracts. As illustrated in the figures, payment may be made through PayPal, actual transactions by check, or wire transfer (for example). These payments may be tracked through the website, and invoices may be generated.

The GAS administration staff also transfer a view of the dailies into a portion of the database accessible to project customers through the web servers. Based on the dailies, the project customers may provide secure online feedback through the appropriate website (the screening room). The screening room is a secure website set up by the GAS administrator, and enables the client to effectively manage his project. Because feedback may be rapidly obtained, changes may be implemented before many resources are expended on incorrect or undesirable work product. The GAS administration staff translates the project customer's comments into actionable job modifications, and relays the modifications to individual studios or artists, as needed. The request for revisions may be received through email or other messaging means. These requests are also stored in the database for future reference. The modified files are then sent back as new files (source code control system). The new files are then posted to the screening room using the work module by the GAS staff.

Often a conventional (usually 2D) creative shop will handle scripts, concept art, sound recording, and then access the GAS. Upon delivery and approval, the script is taken up by two GAS departments: sound recording and script breakdown. The director, talent, and mixers meet to create and slug the voice track for the project. The script breakdown department takes the script and extracts the necessary assets from it for creation.

From this asset list, concept art tasks are assigned to the artists. The artists create all necessary concept art and orthogonals and deliver then back to production. Production staff of the GAS then assigns these assets as modeling tasks or matte paintings, as necessary. The concept art is also delivered to the storyboard artist and director, who then design storyboards for the feature.

As the modeling tasks are performed by the 3D department (which may include both internal and external artists), the director and editor work on the animatic. The finished animatic is delivered to production, a shot breakdown for layout and timing are performed.

To make the pre-production process more efficient, it is possible to create a database of least cost resources. These resources could include digital storyboards, props, locations, and characters that are reusable. Additionally, it is possible to create a digital asset management database, which creates a quick storyboard or quick 2D or 3D model based on reusable characteristics. This database could also include voices and music as part of the digital asset management.

Meanwhile, the modeling team sends finished pieces to the rigging and texturing departments. The texturing department works through the majority of the remainder of the stages on shades and textures, until the lighting phase is reached. Textures automatically appear on the models as they are completed, throughout the blocking and animation stages, through the technology of the GAS. More specifically, the dependencies tool enables file searching and matching to update the models.

In the pre-build phase, it is generally too risky for scheduling and budgeting purposes to front load any of the work. Simply put, it is faster to draw than to model, which is why concept art is done in 2D rather than 3D, even when preparing for a sequel film. However, by developing a database based on generic human characteristics and features, it becomes much simpler to model in 3D. Additionally, such a database enables remote artists to work with a centrally located headquarters much more easily.

For example, police sketch artists use a library of features that are generic to the human race. A sketch artist might be able to choose a set of eyebrows from one of a hundred generic eyebrow sets, based on a description from a witness. Similarly, the GAS features a database of such generic human characteristics. Through this reusable tool database, it is possible for an artist to quickly access features and model in 3D. Additionally, the database includes well-known behaviors. For example, if a character is supposed to swagger, the particular walking trait could be stored and reused again. By labeling the particular gait of the swagger with a certain name, it is possible for multiple artists to access and use this gait consistently throughout the world.

Generally, textures that are required for animation and SFX-are completed first. The rigging department works with the same referenced-files to create animation rigs, which are concurrently tested and debugged by the animation department. The modeling department works on morph modeling for facial animation.

Once rigs are finalized, and the shot breakdown is complete, all artists enter the layout phase. Shots are generally coordinated based on content, and camera block diagrams are generated to accurately assess the blocking position for each shot.

Once the layout is complete, animators generate blocking shots to establish the basic pace of the animation. At the same time, stills are taken from the layout shots and a new 3D animatic (pre-vis) is created using that material. When the blocking shots are completed, video previews are generated to replace the layout shots in the animatic. Each animator is assigned shots and presented with a clip from the animatic, containing his shots and the adjacent shots. Body animation then begins.

Once each body animation shot is completed, the facial animators and the TDs (for SFX animation). This work may be done concurrently or sequentially, depending on the project's needs, and the facial animation is loaded into the SFX shot as an animation file. Secondary animation, if required, is also preformed at this time.

Once the animation and textures have been approved, shots are transferred to the lighting department. Key lighters develop a lighting scheme for each scene, and hand down basic light rigs to each of the lighters. Render tests are generated throughout this phase, and composite files are created.

The scenes are then assembled by dropping objects where necessary. Objects are also constructed from components (which may be stored in the reusable object components database), where required. The outputs of certain jobs are provided as needed to subsequent jobs, until all objects and scenes have been completed, collected, and inserted into the appropriate scene sequence. The appropriate scene sequence is determined by shot numbers, numbers with letters, or other means known to those of skill in the art. It is determined which scenes need inputs from previous scenes before production by the production staff.

During all stages of production, a snapshot of the current state of production is maintained in the project snapshot database. It is possible to view current status of the project, or project history. Every item in the database may be accessed by a query from the database regarding the current status. As each object is created, it is added to the objects database by artists and administrators. An artist may upload a file, as illustrated in the figures, and the administrator must approve the file before it is added to the database.

As a final step in the composition of the project, dialogue and music may be added. Dialogue and music may be added during anytime during the creating of the storyboard. Often, dialogue and music are created during the production process to help animate scene rhythm and lip-synchronization. Voiceover is also usually added at this end stage.

Finally, the completed project may be exported to DigiBeta or other digital media known to those of skill in the art. Once exported, the digital production may be edited using specialized digital tape editing equipment, for example, Avid or Discreet Combustion. Specifically, the project is rendered frame by frame. An average feature film represents 4-10 terabits of information. Each of the frames are loaded into the rendering farm and rendered in layers. These are loaded into the compositing machine (combustion machine) to combine the layers. Once the layers have been combined, they are edited in the editing machine.

Lighting stills and animated lighting previews are presented to the director. Once each shot is approved, it is set for final rendering, as needed, and sent to the post-production department.

Typical checkpoints or milestones include the following. Model turnarounds and stills represent a first marking point of progress. Model turnarounds (a 360° view of the character) for the main characters in the set pieces will be delivered untextured for approval and revision. A second checkpoint involves matte painting. Matte paintings for the background, together with sample camera moves and angles, are delivered. Model revision turnarounds represents a third checkpoint. If necessary, turnarounds for the revisions requested after the first model turnaround should be delivered. Subsequently, rig/animation tests are the fourth checkpoint. Rig tests containing animation should be delivered to examine mesh deformations for body and facial animation. SFX tests represent the next checkpoint. Preliminary tests are performed for any needed SFX (e.g., fur, cloth, or the like) and presented for approval. Subsequently, blocking shots are reviewed to match the storyboards. Body animation tests are then performed for all shots delivered for approval and revision. Facial animation tests are then performed. More specifically, the facial animation for all shots, in addition to body animation, are presented for approval and revision. The ninth checkpoint is a full animation revision. In this phase, full animation tests, including SFX tests are delivered for approval. Subsequently, texturing is reviewed in stills and animation tests. As the eleventh milestone, the final unlit animation files are submitted for last minute revision and adjustment. The lighting tests are then performed by lighting stills of animated sequences delivered for approval. Comprehensive tests of animation, textures, SFX, and lighting are delivered for rendering tests. Final image sequences are then delivered to the post-production facility for mastering during the rendered frames milestone. Finally, a final master is finished and delivered. Test sequences are often rendered as 3D, 2D/toon-shaded, and pure 2D.

Components of the GAS

One aspect of the GAS is the studio mogul. The studio mogul system includes multiple software modules that provide various production management features. The module-based approach enables rapid system modifications and addition without requiring drastic system-wide changes. The module based approach also allows production managers at multiple remote locations as well as oversight personnel at a studio or related client company to input data.

Some features of the studio mogul include: production scheduling, real-time production management and tracking, on-site/off-site secure file transfers and collaboration, digital asset management, revision and approval management, off-site production management, financial/budget tracking, remote approvals, and user management and usage auditing.

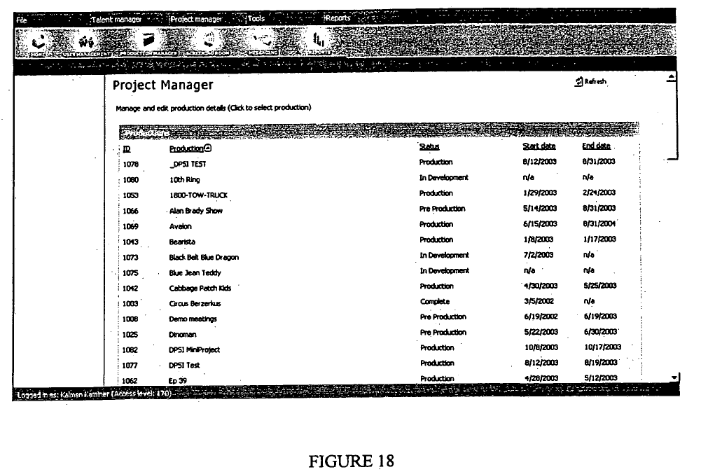

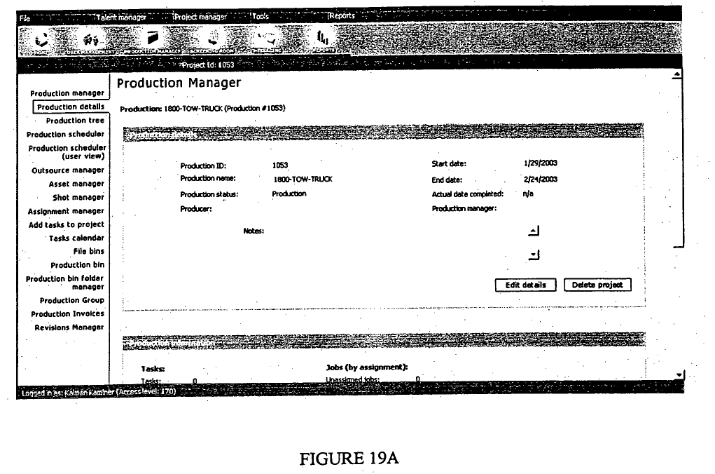

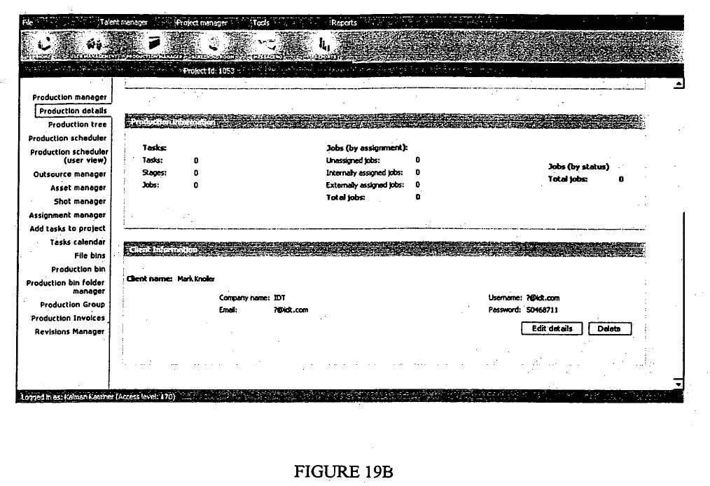

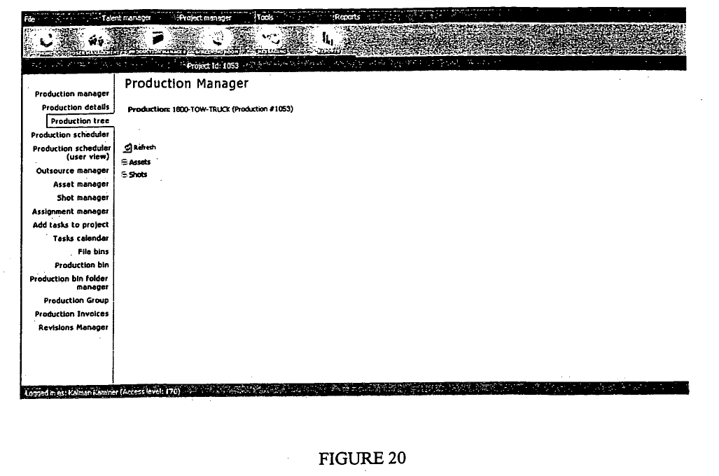

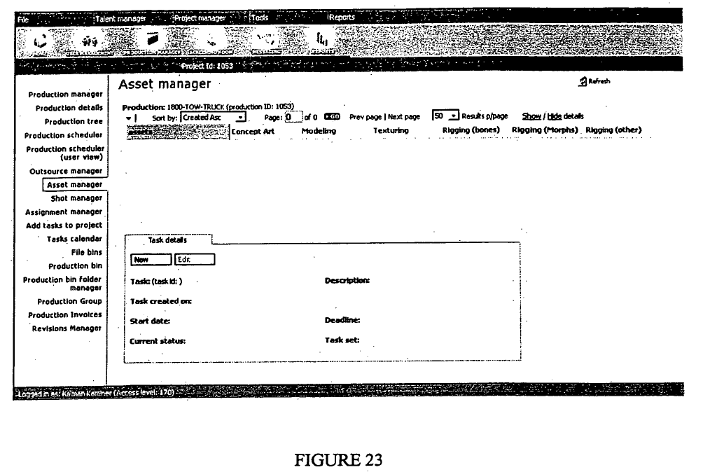

FIG. 18 illustrates the project manager, which enables viewing, access, and management for pending projects. The production manager (illustrated in FIGS. 19A and 19B, as well as FIG. 20) provides a “heads-up” summary of a given production. Information is presented in a one page summary format that provides current production status snapshot information. The snapshot information may include brief schedule information, task assignments, and progress, as well as stills and video files of concept art, storyboards, animatics, models, animation, or the like (as illustrated in FIGS. 23-27).

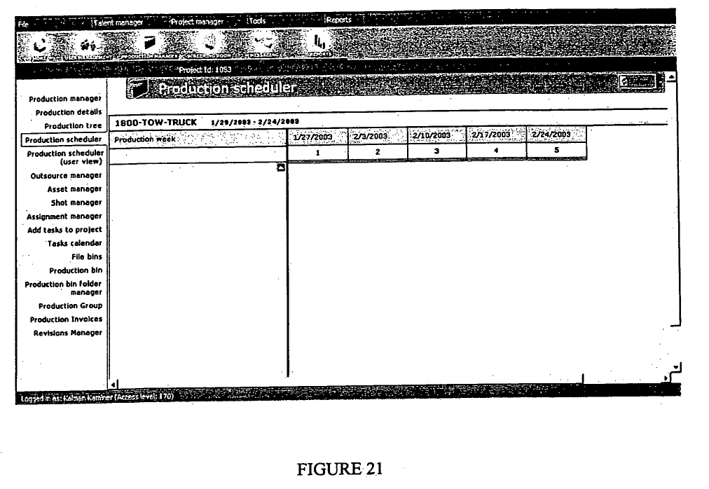

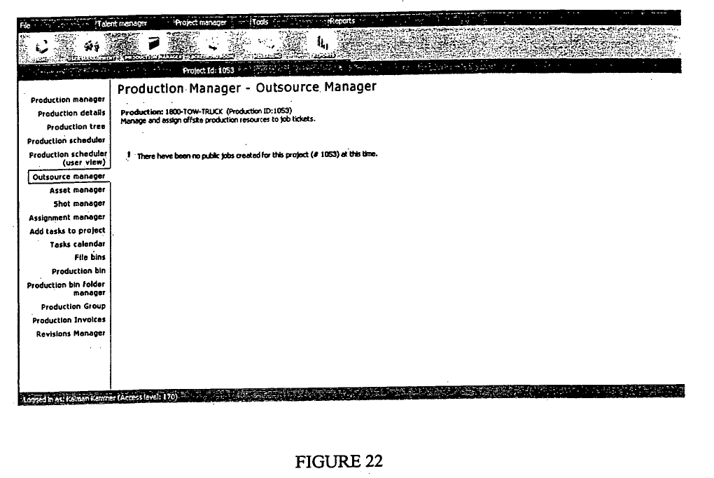

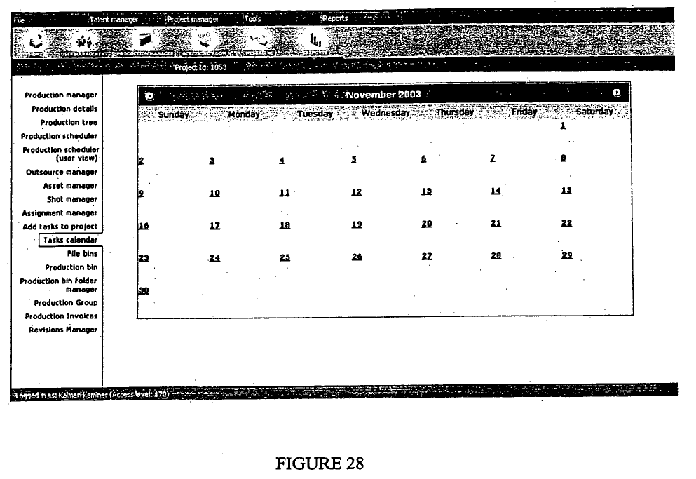

The production scheduler (illustrated in FIGS. 21 and 22) enables creating and maintaining a clear production schedule. The scheduler provides information in either timeline or calendar format about both ongoing and future tasks, as illustrated in FIG. 28. Schedule information may be updated in real-time, thereby allowing for a near instant snapshot of current production progress. In addition, the scheduler can automatically notify an individual (or group) about any type of schedule change (i.e., task reassignment, schedule revisions, or the like).

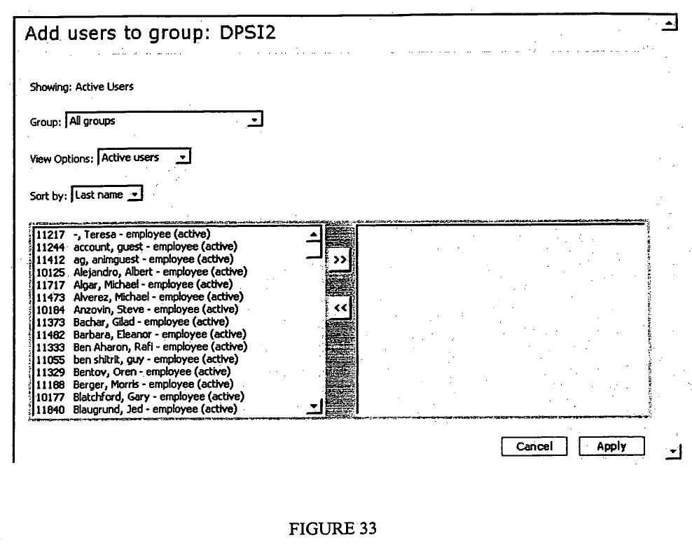

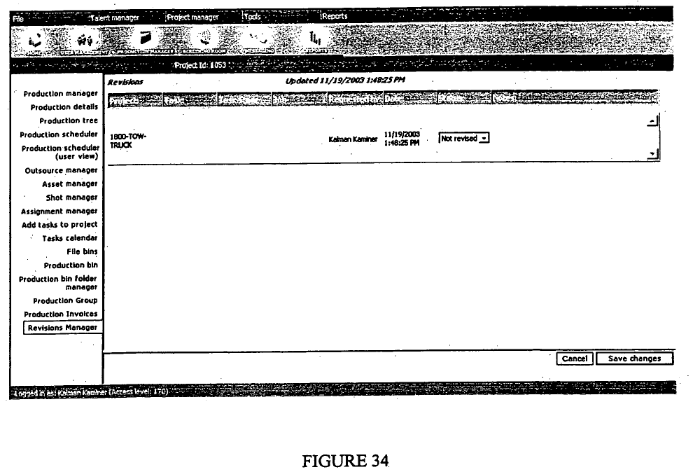

The assignment manager module provides a view of current production personnel and their current or future assignments, as illustrated in FIG. 33. This module provides the ability to carefully plan production personnel workload and to create an efficient workload. By interfacing with both the scheduler and financial control models, the assignment manager can provide information about problematic schedules, as well as providing cost information for each given task based on assignment.

The asset manager module (shown in FIGS. 23-27) is useful for breaking down a given production's script into individual assets to be created. Once an asset has been defined, the various tasks required to complete the creation of the asset may be assigned to individuals or groups, and progress may be tracked via the asset manager or production scheduler.

The actual digital files used to create the asset may also be stored in the system. This feature enables file sharing and collaboration, as well as unlimited version rollbacks.

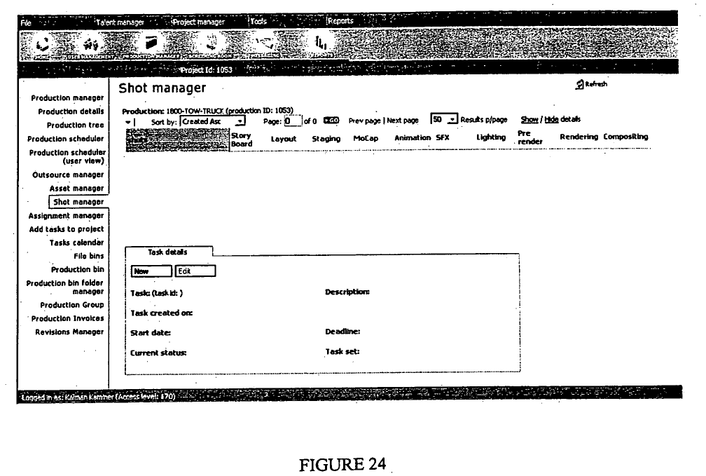

Like the asset manager, the shot manager (FIG. 24) enables a breakdown of the entire production into individual shots. Once a production has been broken down into individual shots, the individual tasks required to build a given shot may be assigned to individuals (or groups). Like the asset manager, the shot manager can store the individual files used to create the entire shot.

The messaging and collaboration tool of the GAS is designed to facilitate messaging between individuals and groups, as well as for individuals and groups to receive automatic messages and notices generated by the GAS. Features of the messaging and collaboration tools include verifiable message transmission and reception by individuals/groups, as well as automatic alerts and notices. Messages may be sent via e-mail, internal messaging system, or other means known to those of skill in the art. Alerts may be sent via e-mail or sent to other third party instant messengers or by facsimile for example.

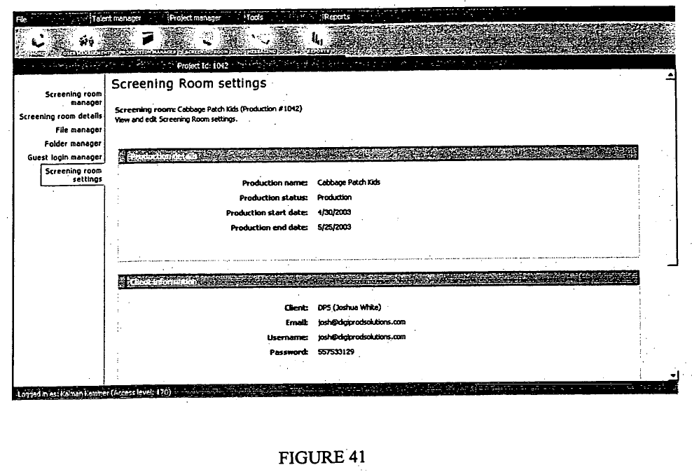

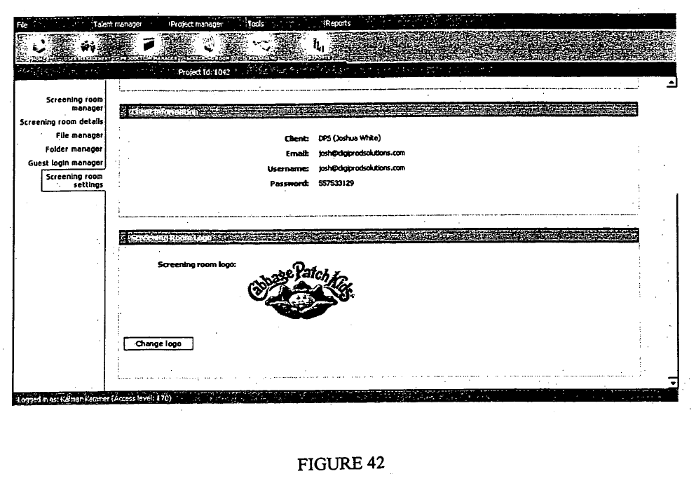

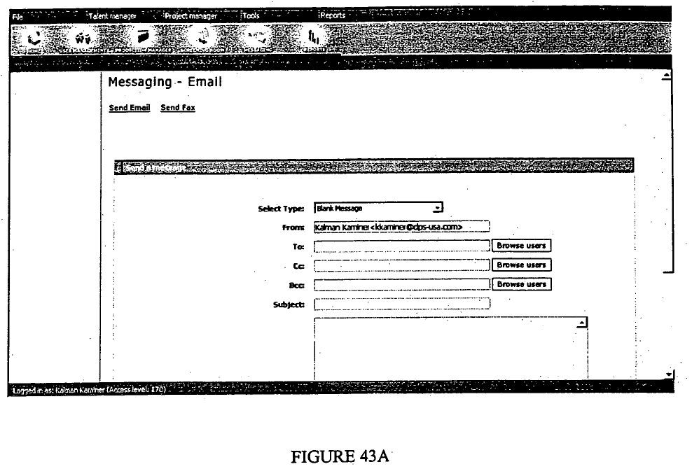

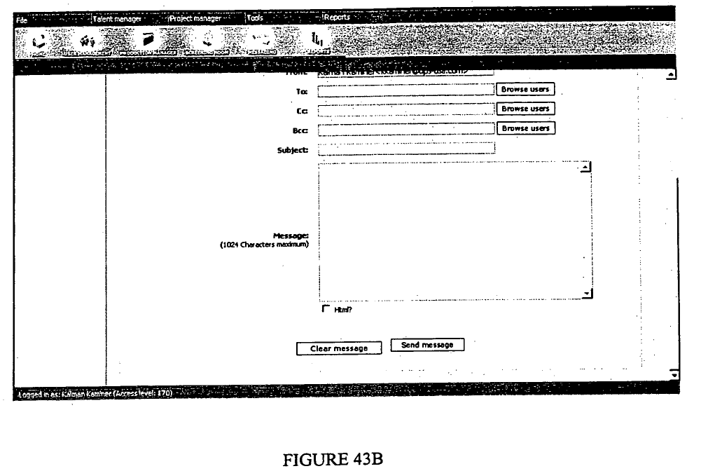

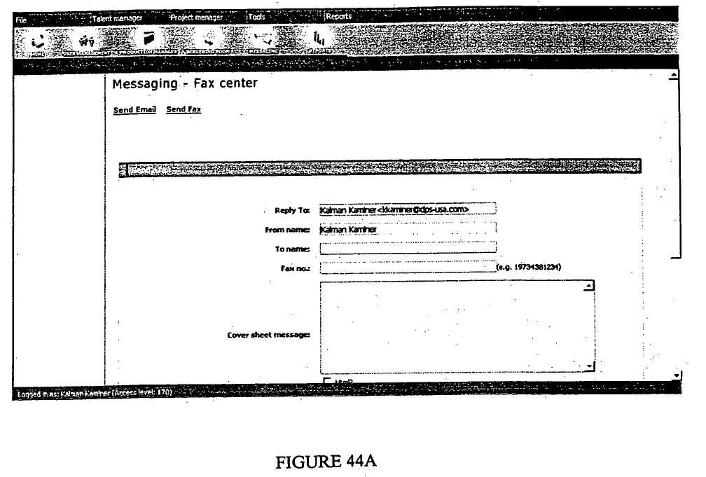

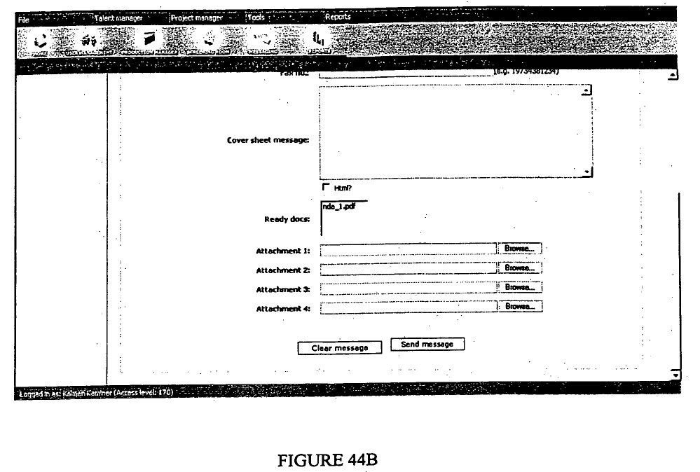

FIG. 42 represents the bottom half of the screening room settings shown in FIG. 41. FIGS. 43A and 43B show a screen that a user might use to send a message via email. In the send a message field, the user enters to and from information, as well as the text of the message. It is possible for a user to browse other users to make sure that the email address used is correct. FIGS. 44A and 44B illustrate the messaging of a fax center. In this screen, it is possible for a user to send a message via facsimile.

The screening room module allows for posting material to a secure site for remote approval and revision requests. This enables quick approval and a rapid revision schedule. Stills/video (concept art, storyboards, animatics, motion capture files, models, animation files, and the like) placed in the screening room may optionally be encrypted to enable limited viewing.

Before a critical job is granted to a C level affiliate, staff members at the GAS generally examine and test the qualifications of the C level affiliate. For example, a test job may be issued, and the outcome evaluated. If the work delivered by the C level affiliate and the experience of the GAS with the affiliate is satisfactory, the C level affiliate is then tested for scalability. If the C level affiliate satisfies the needs of the project, the C level affiliate may receive the critical job. The C level affiliate will continue to be monitored throughout the production cycle.

The security and auditing models may run in conjunction with all other system modules and provide an ongoing review of system security. The security module provides a running list of system events by analyzing each individual module's operations and logging both normal and abnormal system performance. This enables detection of real-time security violations, as well as forensic analysis of system events.

All LAN operations may be secured by security hardware and software, in addition to internal private addressing schemes and multiple domain structure for increased security. Point to point communication may be DES encrypted over a VPN with private addressing on both ends.

All systems may also be isolated into individual domains for enhanced security. Both inbound and outbound public traffic passes through multiple firewall and packet filters for enhanced durability. Public facing machines are isolated, and have dual NICs for both inbound and outbound traffic. Internal machines are protected under multiple domains and firewalls.

All server hardware resides in an environmentally controlled security center. Access to the security center is limited. Since the data center is part of a telecommunications company, physical security meets federal standards for carrier “telecom hotels” (e.g., multiple and redundant security system, limited access, 24 hours/7 days a week monitoring, full environmental control, and armed security personnel).

Additionally, video and image files can be watermarked with both visible and invisible watermarks. Video files may also be encrypted to control playback.

Tools of the GAS

Generally, an animator generates 1-4 seconds per day of feature film. However, reusable tools may improve efficiency of this process. These tools may be linked in a database. One such GAS tool is a dependencies linking/searcher tool. This dependencies tool identifies to the animators missing portions of files that need to be added.

For example, if an animator chooses to use a chair, the chair may require a certain type of floor to be consistent with other scenes within the feature film. The dependencies tool identifies the particular floor that is necessary and alerts the animator that the floor file is missing and where the floor file may be found. Additionally, the dependencies tool protects against accidental overwriting of animation objects, which often happens. Through this reusable database, searchable by the dependencies tool, it is possible to protect against these accidental overwrites that result in the loss of weeks of work.

A set of tools has been developed to facilitate consistent, efficient character animation between several animators, regardless of technical experience, software training, or cultural bias. The GAS provides character controls, presets, and macros to enable many animators to use the same set of expressions and extreme poses for specific characters.

Cultural differences may be obviated through the use of meta-data sent out with characters and other objects. These proprietary buttons and sliders ensure that a character whose smile is being created in Bangalore, Dublin, or Massachusetts may be consistent, while allowing the artist room for expression and creativity. This meta-data also speeds production and enables less experienced animators to perform beyond their usual level of quality and skill.

One of the first tools includes a slider/spinner base control panel, which organizes and presents every control within the character. Control objects were created in the viewport, such as a hand icon for a hand and arm controls. Controls were added in a separate panel for each of the appendages, containing area specific animation controls. In the case of the hands, finger splays, finger curls, and individual knuckle rotation controls were presented. Along with these controls, a preset override control was added. Using the preset override, technical directors and lead animators may provide a vocabulary of expressions for each appendage, thereby transferring their decisions about character extremes to the individual animators.

Additionally, the GAS includes an efficient lip-sync and facial animation system. A software based button system provides this function. Animators are presented with a panel containing thumbnail images of each expression and phoneme for a given character. Clicking (punching) the button itself provides a 100% value for that particular expression. There is also a button to zero out the expression, and a dial in spinner for more fine tuning., Custom expression sets were added to these controls, so asymmetrical expressions may be created and easily stored.

Additionally, macros for keying and zeroing out all character controls at once were created. The key all button is incredibly useful in the animation stage, for use with the pose-to-pose method of animation. The pose-to-pose method of animation requires universal key frames for all controls.

The GAS also includes steering and suspension controls. The steering and suspension controls are particularly useful where the characters are in vehicles.

Accessing the GAS

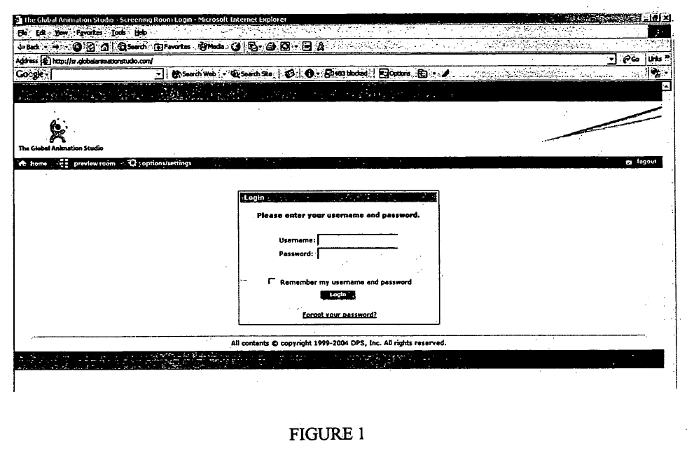

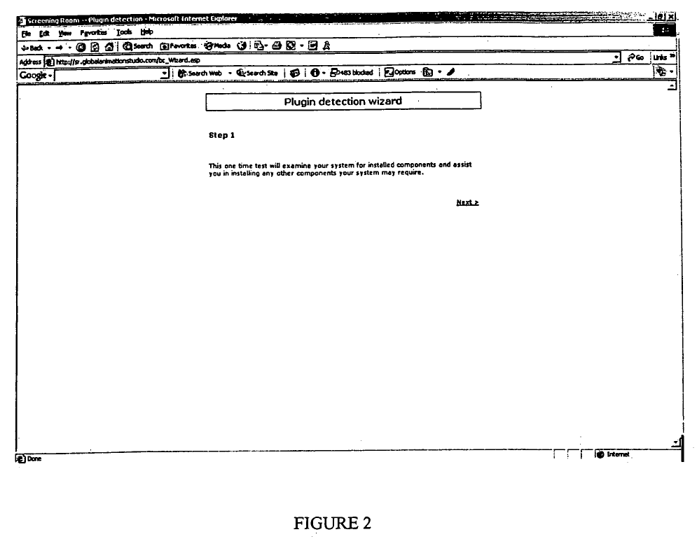

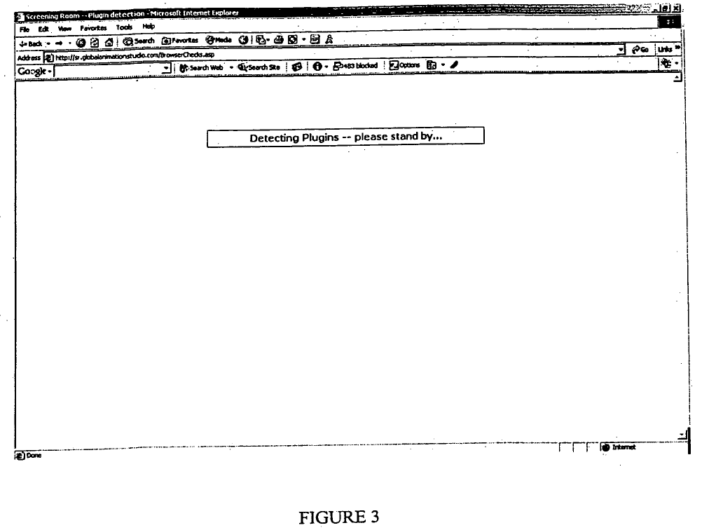

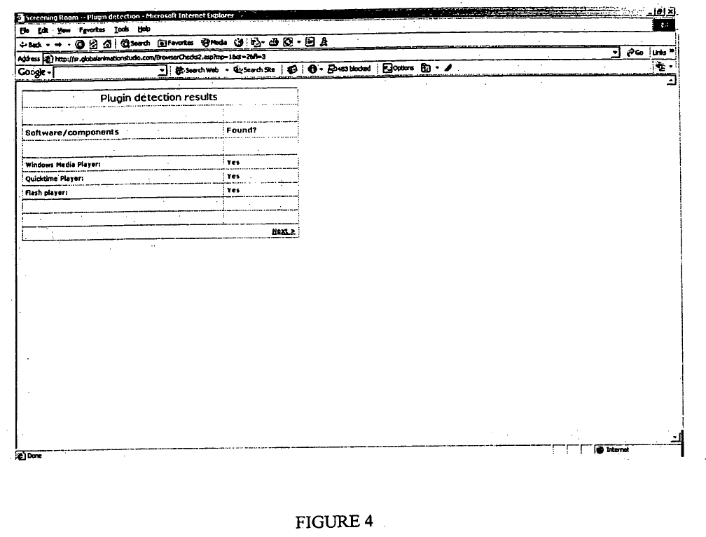

FIG. 1 illustrates an access page for the global animation studio. On this login page, a client or producer may access data regarding the feature film being created in the GAS. As shown in FIG. 2, the first time a user accesses the GAS or when a user's cookie has been deleted, the plugin detection wizard searches for necessary components. FIG. 3 illustrates the detection of the plugins, and FIG. 4 illustrates a successful plugin detection screen.

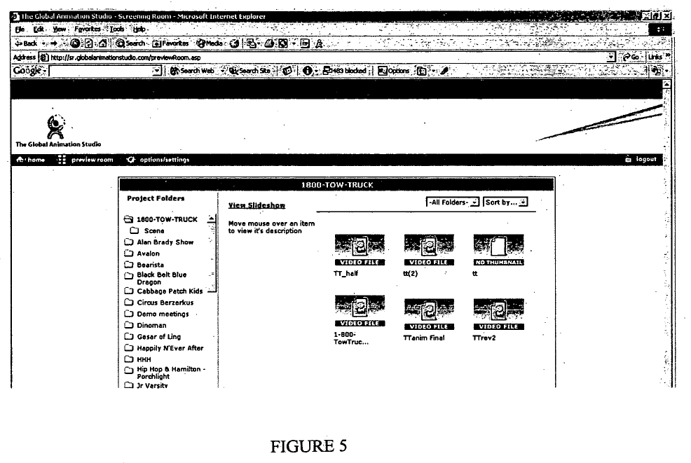

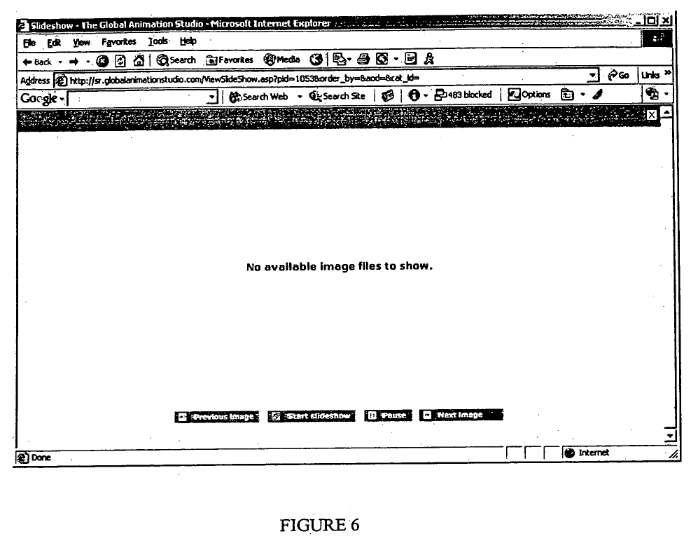

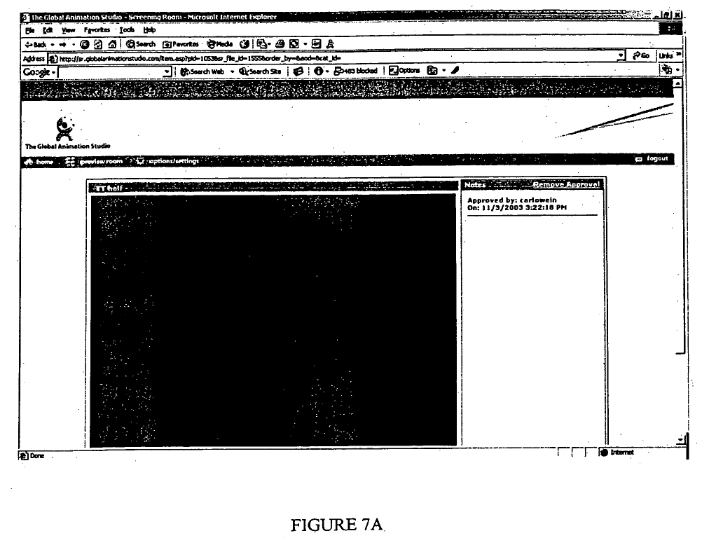

Once a user accesses the global animation studio, he is presented with a list of projects to which he has access. What a user may access may be controlled by his security level, as set by the GAS administration, as well as by encryption. This list of projects is illustrated, for example, in FIG. 5. If the user clicks on a view slideshow link in FIG. 5, he is directed to FIG. 6. In the non-limiting example of FIG. 6, no image files had yet been prepared for the selected project.

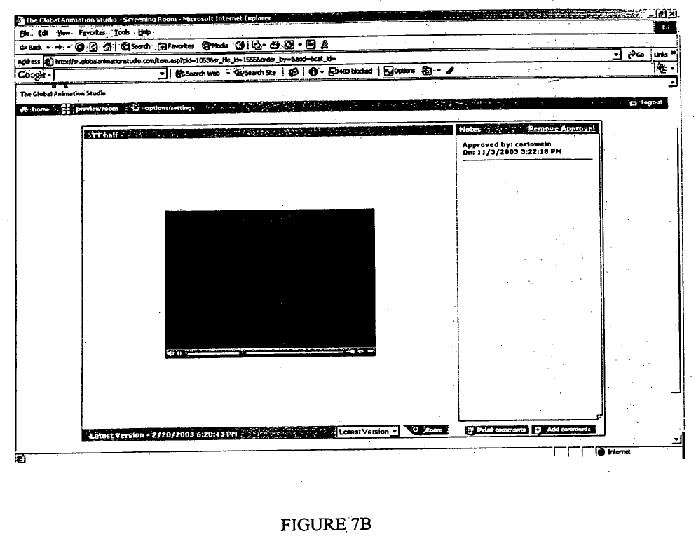

FIGS. 7A and 7B illustrate what happens when a user clicks directly on one of the images in FIG. 5. If the image is a jpeg or other still frame image, that image is simply opened. If the image is a movie version, it is played in Quicktime, Windows or Media Player, or other appropriate movie player.

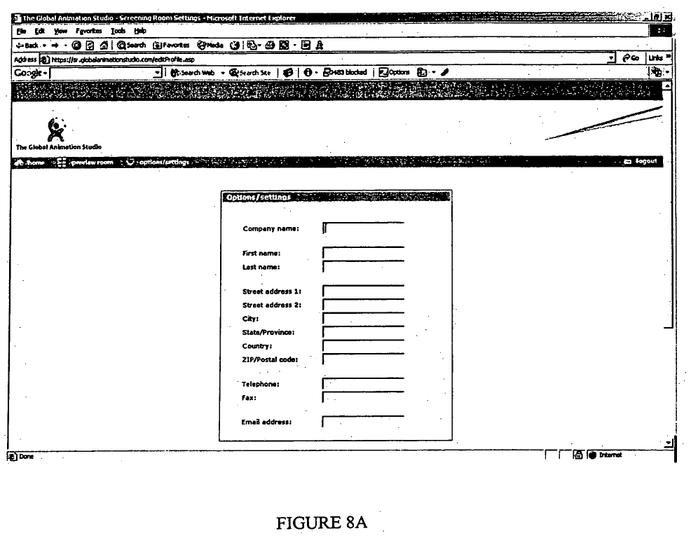

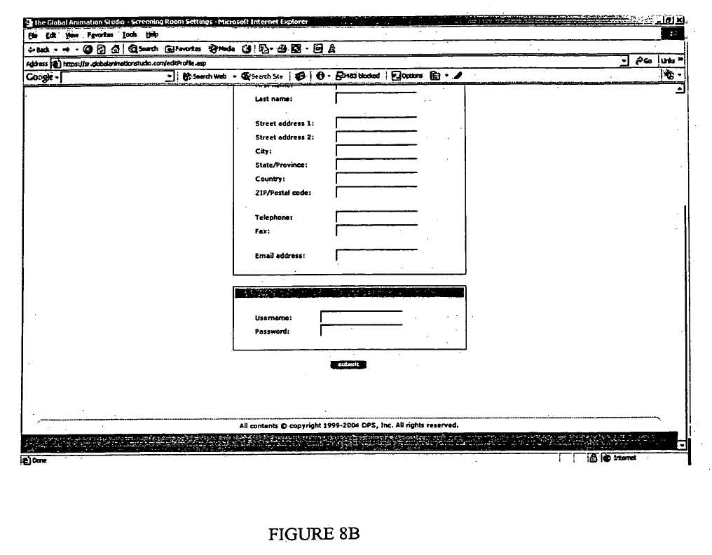

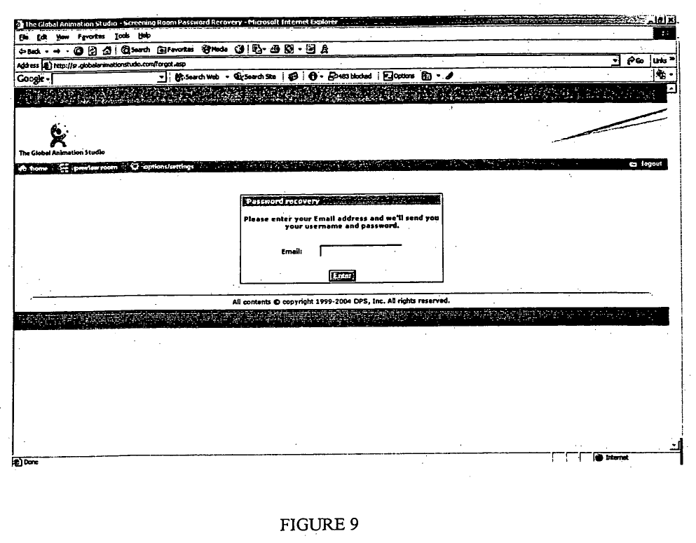

As illustrated in FIGS. 8A and 8B, once a user has entered the GAS, he may alter his personal information such as name, address and telephone number. Additionally, as illustrated in FIG. 9, when a user forgets his password, he can request password recovery and the GAS will send him his password at the email address specified in his user information.

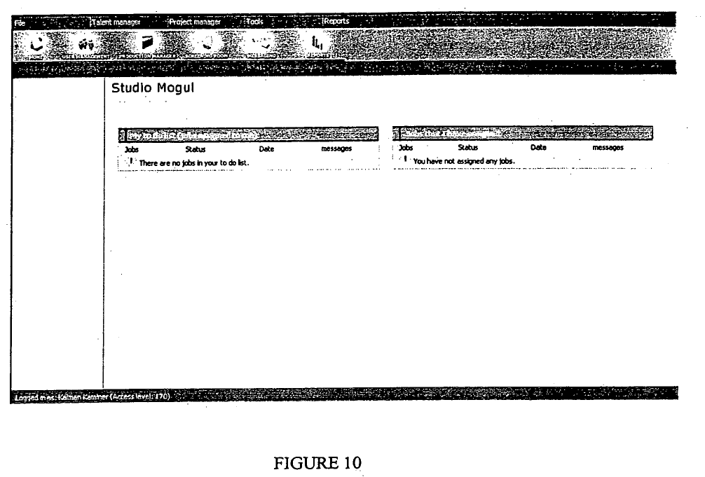

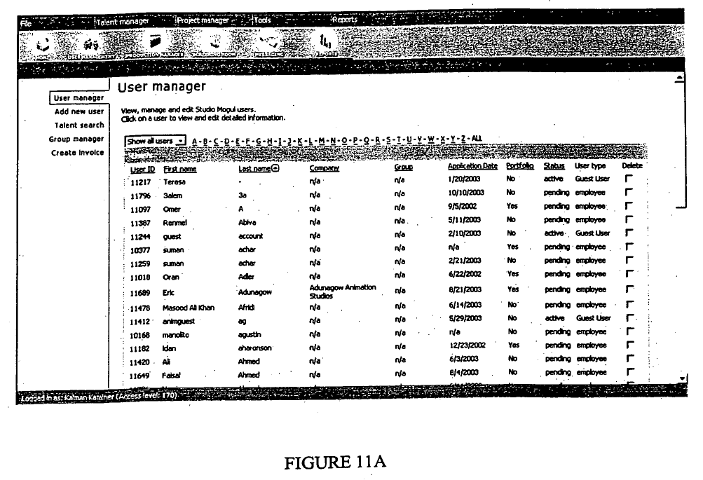

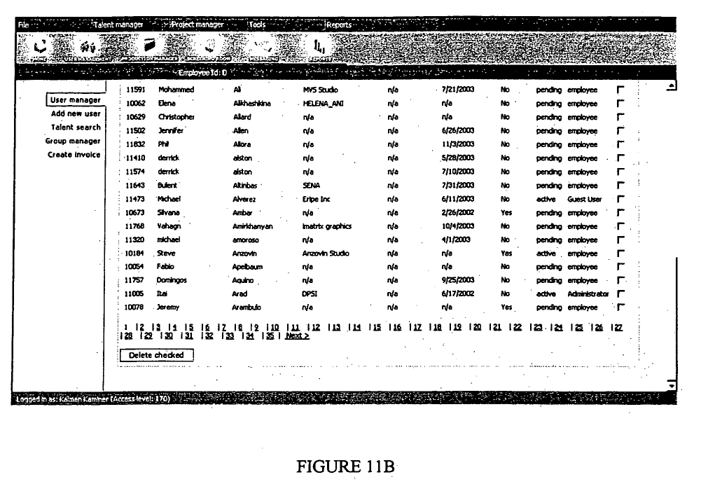

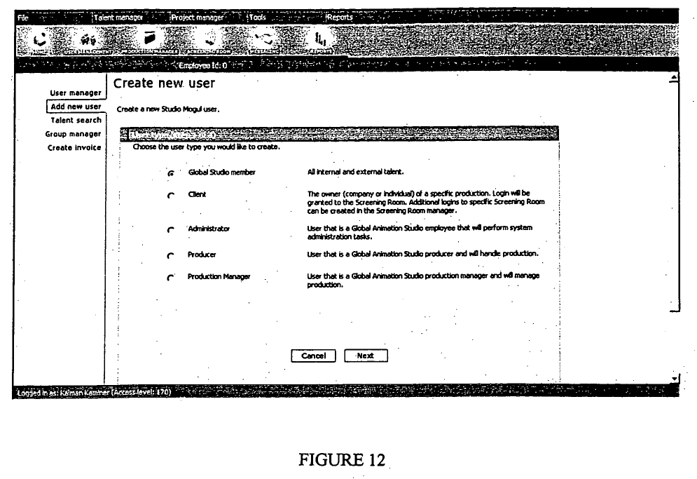

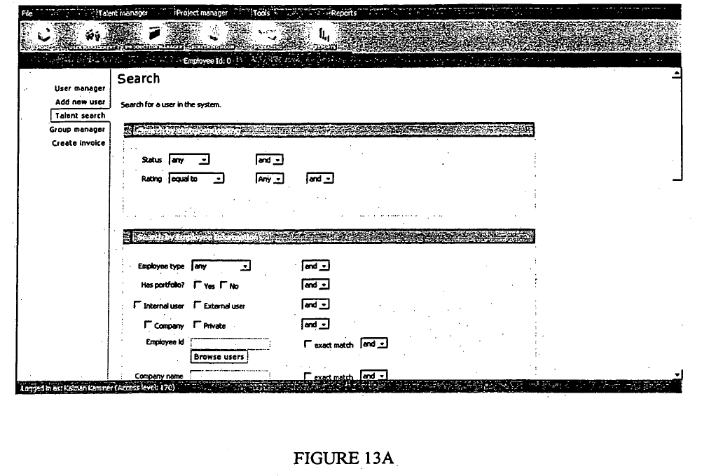

FIG. 10 illustrates the studio mogul aspect of the web mogul. In this particular example, the user has no particular jobs used or assigned. FIGS. 11A and 11B illustrate the user manager, which is accessible only by GAS staff. The user manager enables GAS administrative staff to add, delete, and modify users. FIG. 12 illustrates a screen that a GAS administrator may use to create a new user.

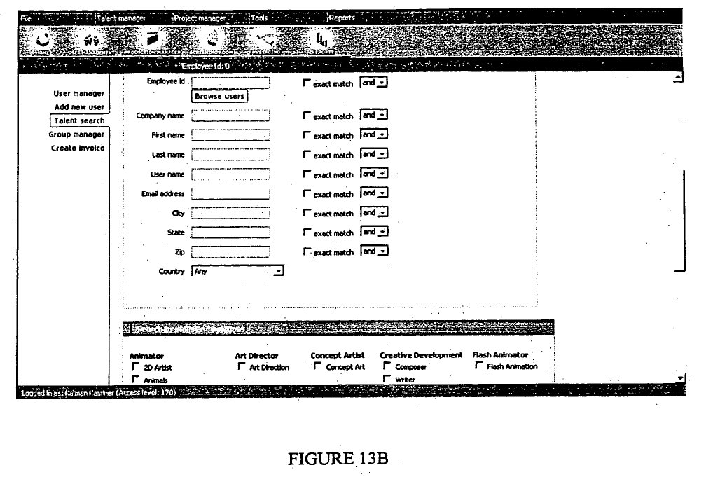

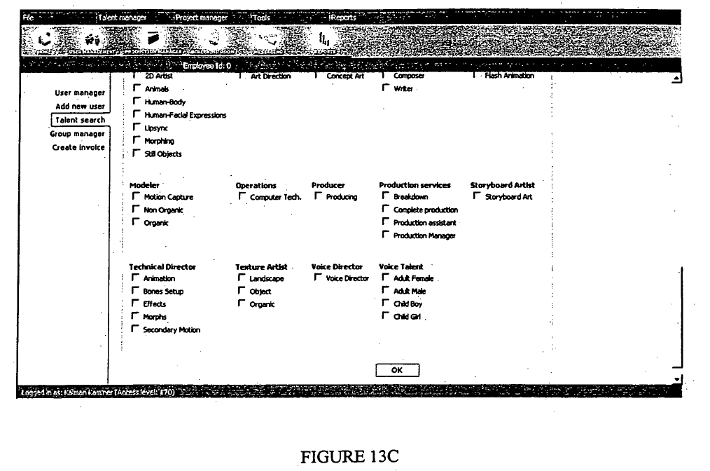

FIGS. 13A, 13B, and 13C illustrate the searchability features of the GAS. Specifically, as FIGS. 13A-13C illustrate, a GAS administrator may search for an artist based on several characteristics.

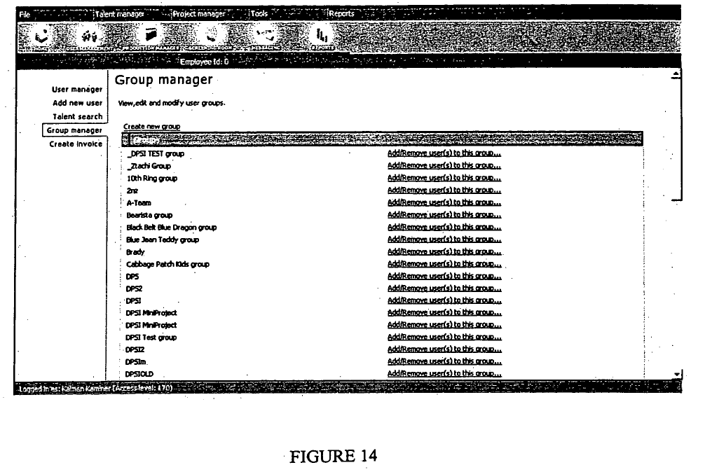

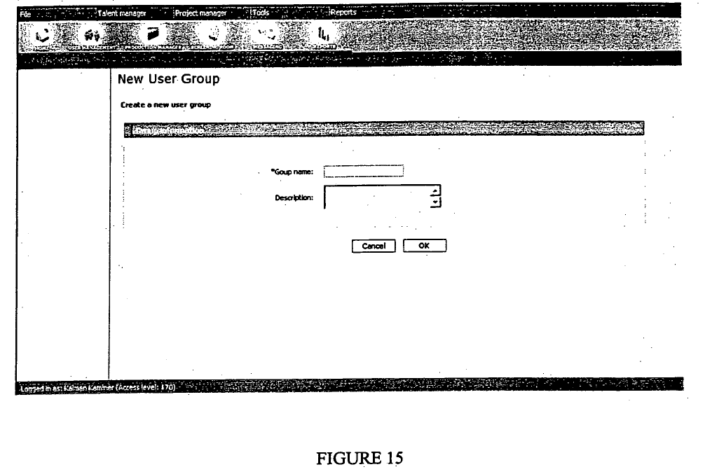

In the group manager illustrated in FIG. 14, it is possible for a GAS administrator to modify, add, and delete user groups. Within each user group, the administrator may also add or remove individual users. This group manager enables greater ease in communicating with members of a specific project. FIG. 15 illustrates how to create a new user group.

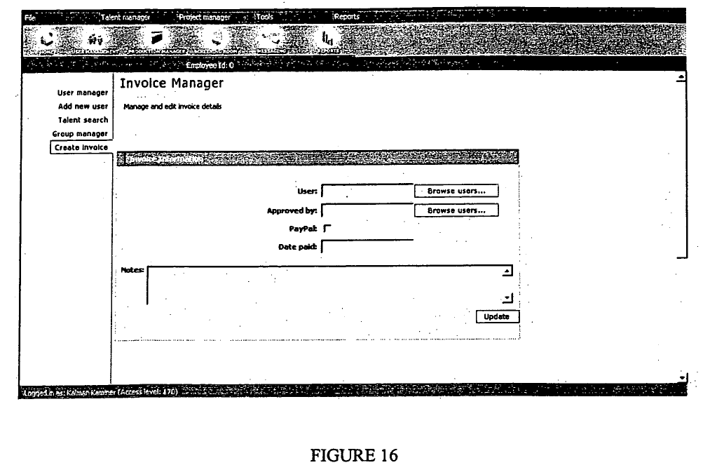

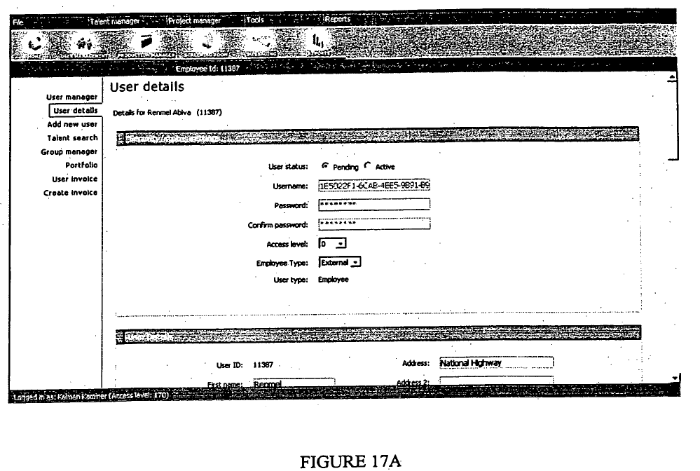

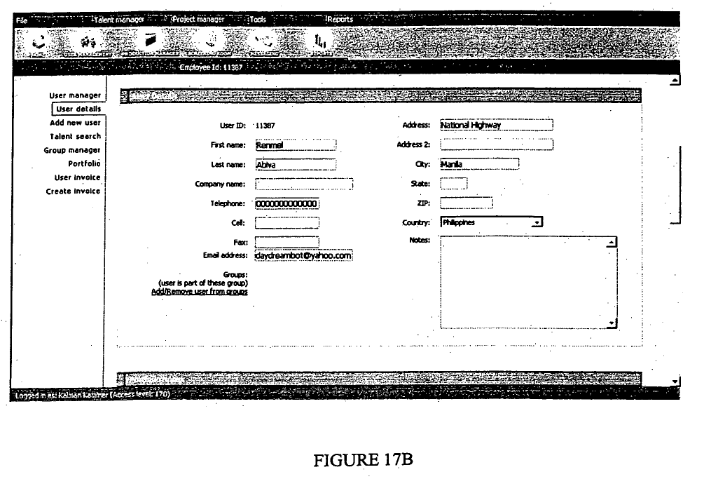

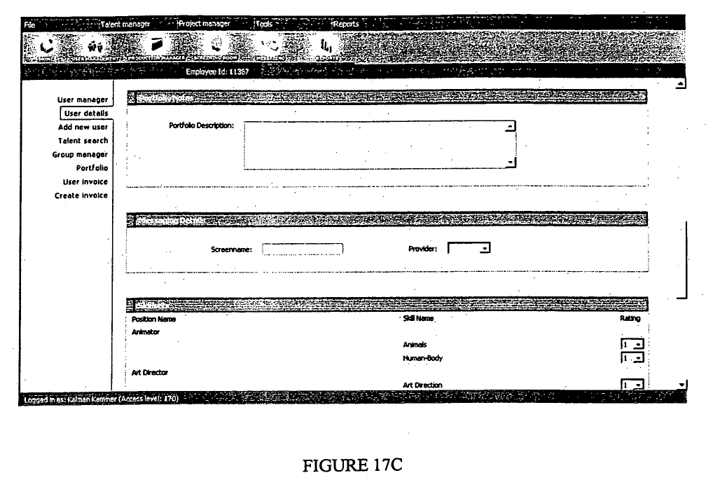

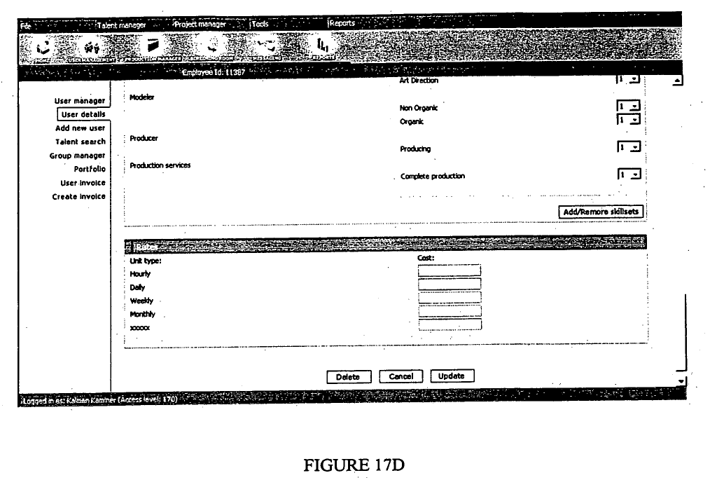

In FIG. 16, the invoice manager is illustrated. In the invoice manager, GAS personnel may manage and edit invoice details. FIGS. 17A, 17B, 17C, and 17D, illustrate user details that may be accessed by all GAS personnel. Individual users may see their characteristics, but only GAS personnel have complete control to modify user data.

FIG. 18 illustrates the project manager of the web mogul. In a project manager, projects may be illustrated by name and id, and the status, start date, and end date of the projects are displayed.

FIG. 20 is a production manager, which provides a listing of the assets and shots created and counted during pre-production. In FIG. 21, the production scheduler is illustrated. In the non-limiting example of FIG. 21, no tasks have yet been assigned for that particular job.

FIG. 22 illustrates one of the more dynamic features of the GAS. More specifically, the outsource manager enables GAS personnel to manage work being done by artists.

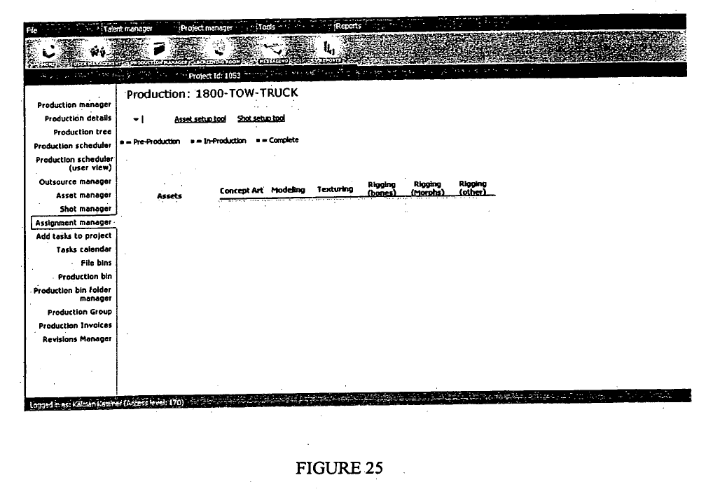

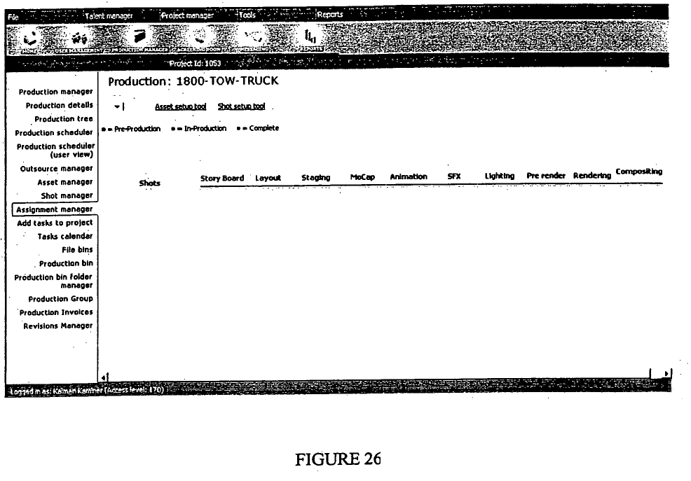

In the asset manager shown in FIG. 23, data relating to the task, start date, current status, and description are displayed. Similarly, in the shot manager of FIG. 24, GAS personnel can access basic data regarding each shot. FIG. 25 illustrates the asset setup tool, which enables GAS personnel to configure data necessary for multiple artists to create and work on an asset. FIG. 26 illustrates the shot setup tool, where GAS personnel can configure the data necessary for multiple artists or studios to work on different shots.

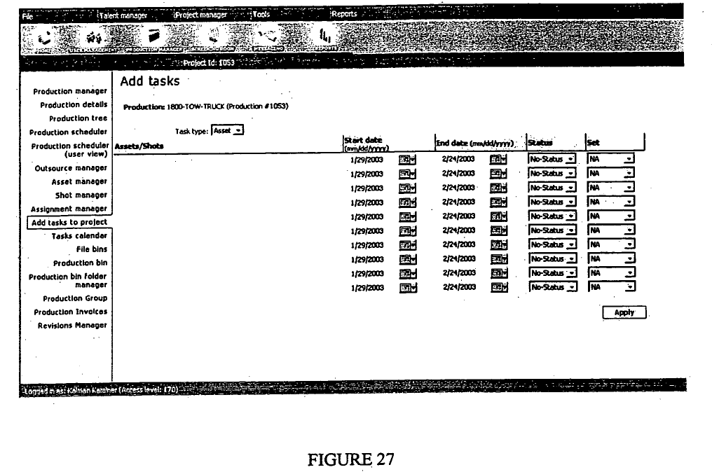

FIG. 27 illustrates an add tasks screen of the GAS. This screen enables an administrator-to set up tasks for work by various artists. FIG. 28 is a view of the tasks calendar. In the non-limiting example of FIG. 28, no tasks are currently active.

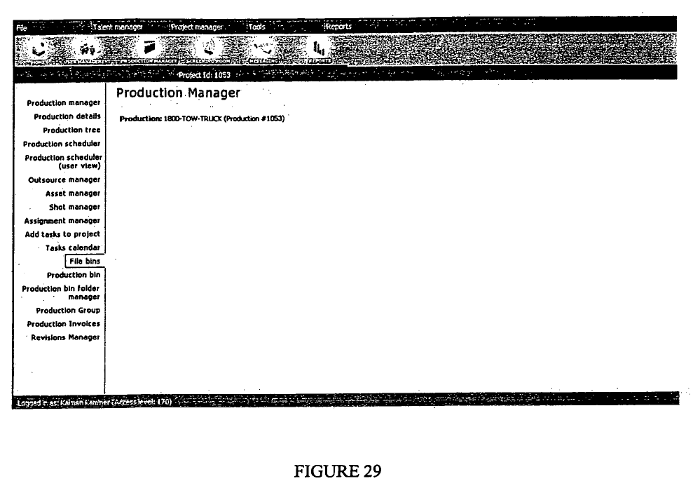

In the production manager, illustrated in FIG. 29, file bins may show available production files.

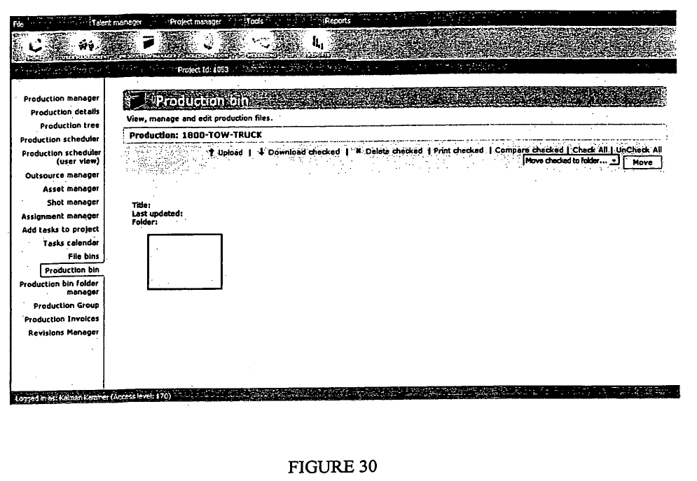

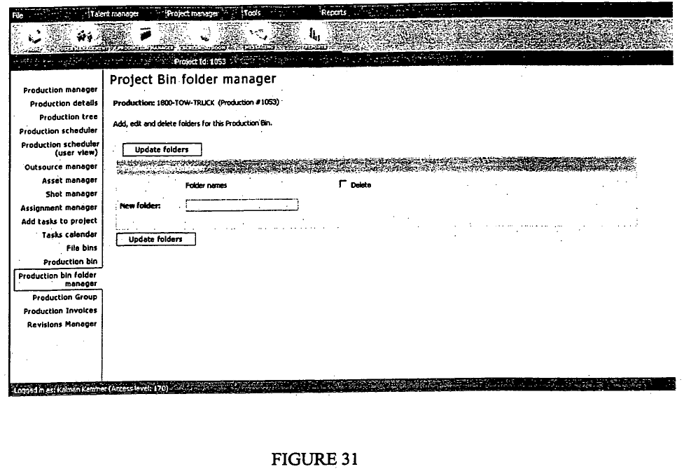

The file bins of the production manager are illustrated in FIG. 29. In the example of FIG. 29, for the project 1-800-tow-truck, no file bins are currently available. FIG. 30 illustrates the production bin for the tow truck project. As illustrated in FIG. 30, a GAS user may upload, download checked materials, delete a checked material, print checked material, compare checked material, and check all or uncheck all of the materials available. In the project bin folder manager illustrated in FIG. 31, a GAS administrator can create or modify folders.

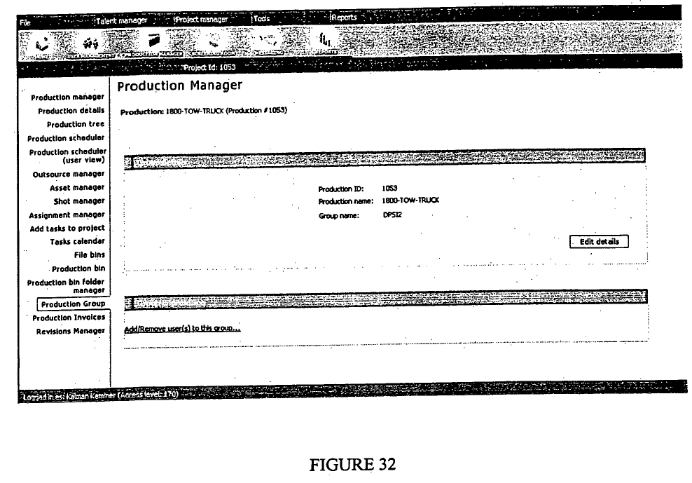

FIG. 32 illustrates the production group of the production manager. The group details, such as the production id, the production name, and the group name may be added, removed, and otherwise edited. Additionally, in this screen of the production manager, GAS personnel may add or remove users to this particular group. FIG. 33 illustrates how GAS personnel might add or delete a user from the group. On the left is a list of available employees and artists. Users to be added or deleted to the group appear on the right-hand side. In the non-limiting example of FIG. 33, no users have been modified.

FIG. 34 illustrates the revisions manager for a particular project. The revisions manager shows the project, the task, the task stage, the job, who requested the revision, when the revision was requested, and what is the status of the revision. It is also possible for a user to enter notes about the revision for review by others.

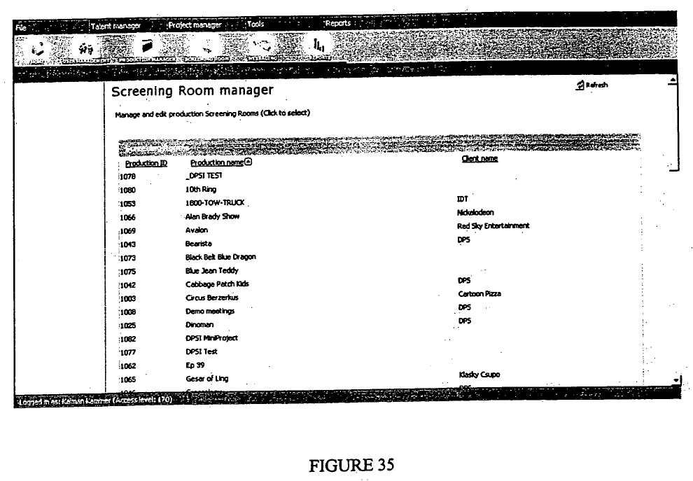

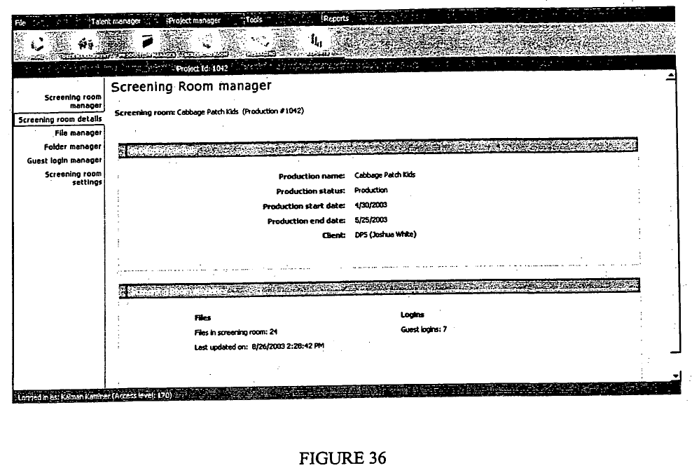

The screening room manager is illustrated in FIG. 35. The screening room manager enables GAS personnel to manage and edit production screening rooms. By selecting one of the productions, a GAS administrator may modify accessibility, schedule, or other features of the project. FIG. 36 illustrates the screening room details for a particular project. These details show the production name, the production status, the start date, the end date, and the client. Other details may also be available for view by the GAS staff.

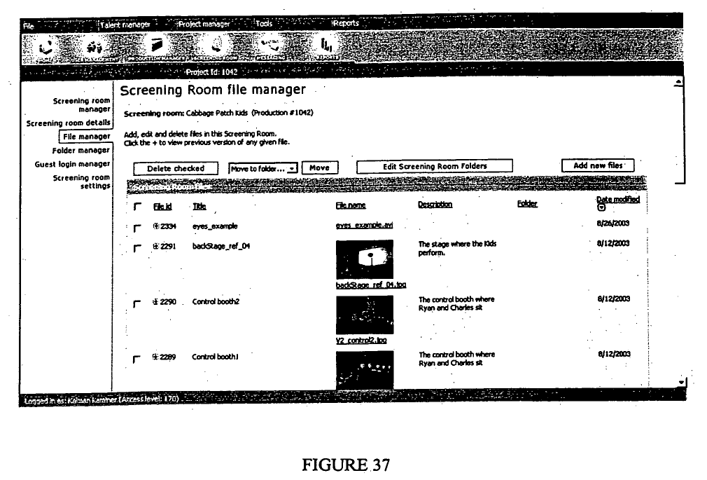

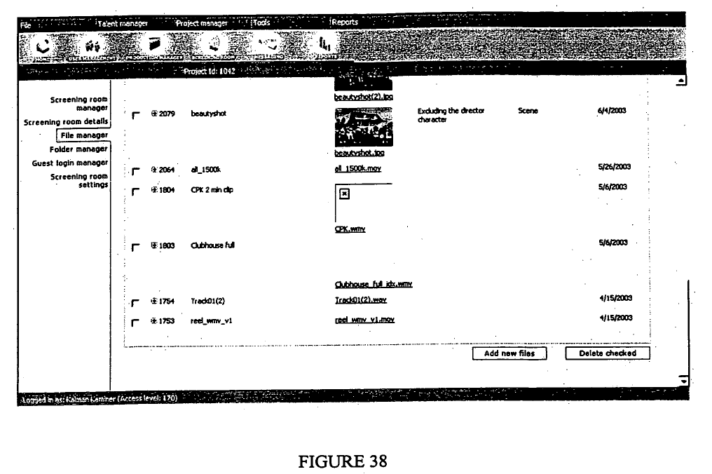

In the screening room file manager of FIGS. 37 and 38, a user may view and access details about files available for each project.

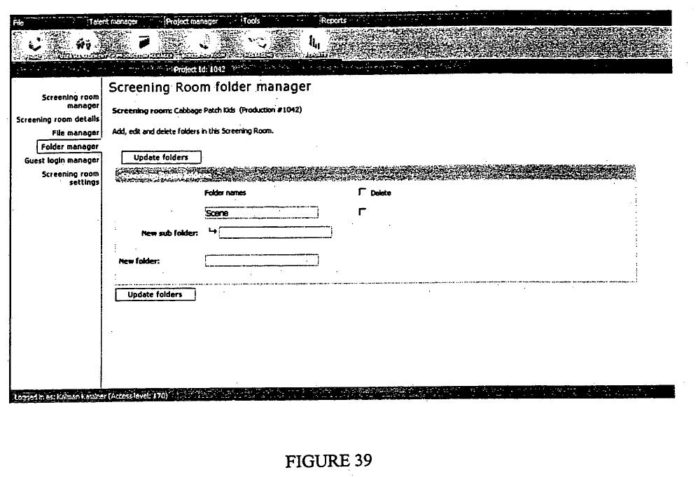

In the screening room folder manager of FIG. 39, GAS personnel may reorganize the folders, so that data may be more easily viewable for users of the system.

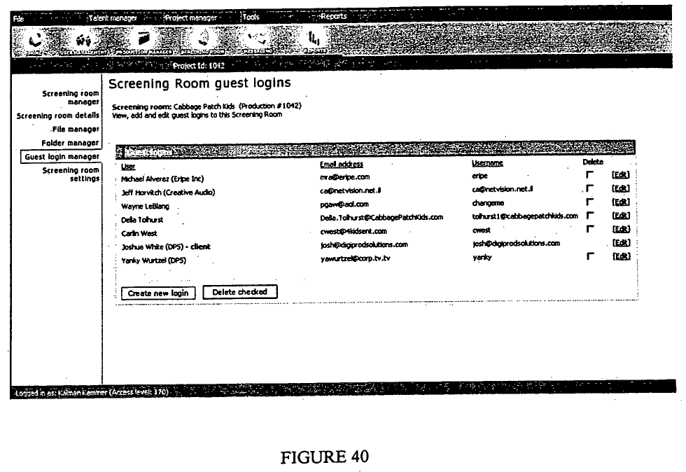

FIG. 40 illustrates one of the security features of the GAS. In FIG. 40, the screening room guest logins screen is viewable to GAS personnel. Through this screen, it is possible for GAS personnel to monitor users who access the GAS.

FIG. 41 illustrates the screening room settings. In this screen, it is possible for administrators of the GAS to modify production details and client information. FIG. 42 illustrates a screening room logo and client information for a project.

FIGS. 43A and 43B illustrate messaging features for a project. FIGS. 44A and 44B show how a user may send a facsimile message using the GAS.

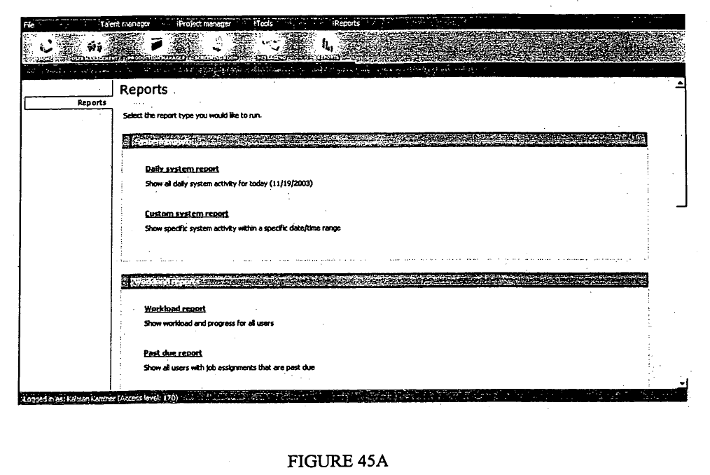

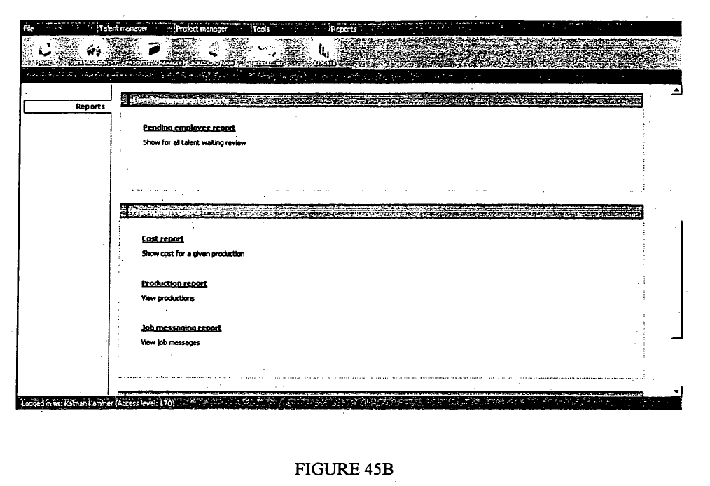

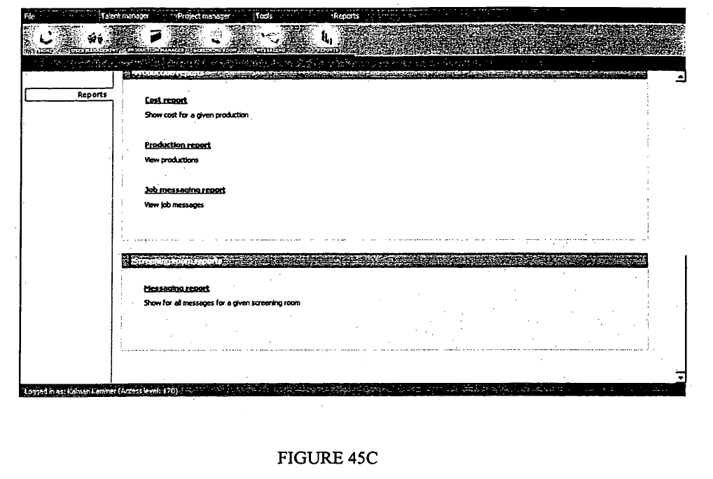

FIGS. 45A, 45B, and 45C, illustrate one of the reporting features of the GAS. This reporting feature makes it much easier for management staff to track the progress, efficiencies, and status check for the system, as necessary. Reports available GAS staff may include, as non-limiting examples, a daily system report, a custom system report, a workload report, a past due report, a pending employee report, a cost report, a production report, and a job messaging report, and a messaging report. These reports enable GAS personnel to easily get a bird's eye view of what has occurred in the system.

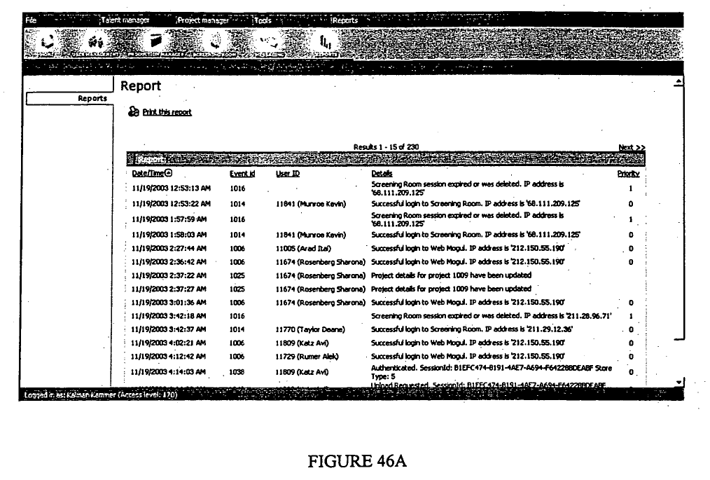

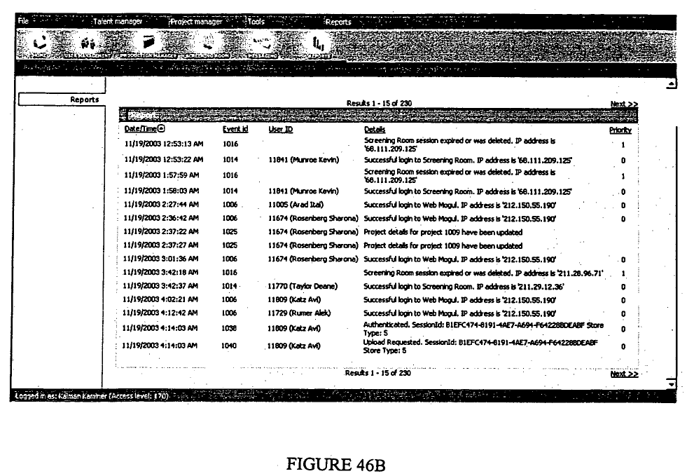

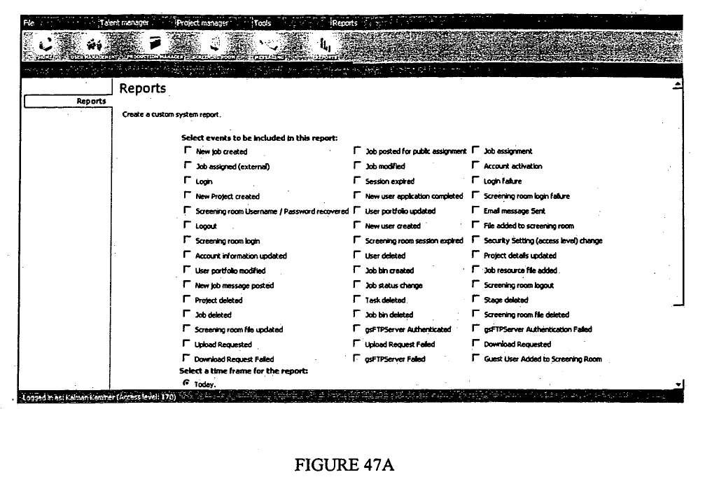

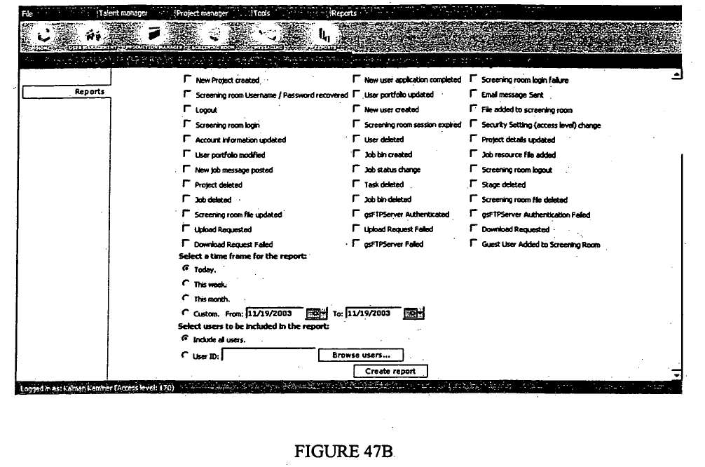

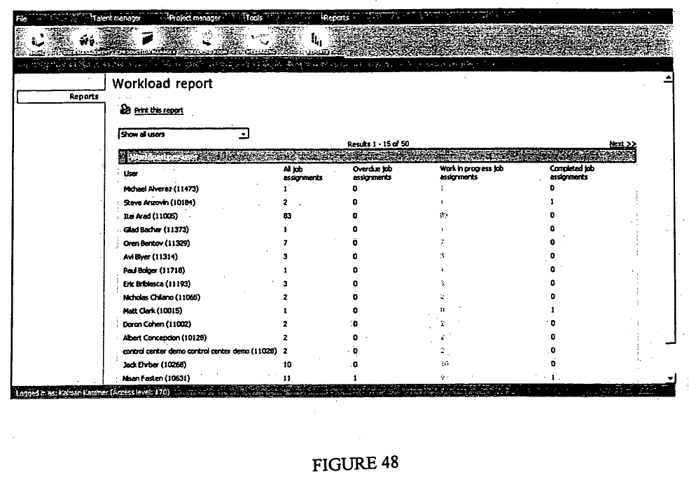

FIGS. 46A and 46B illustrate a sample report. This report is printable by an authorized GAS user. FIGS. 47A and 47B illustrate a screen that enables a user to create a custom system report, based on a user's need. FIG. 48 shows an example workload report. Through this example workload report, it is possible for GAS personnel to determine the performance of individual employees and remote artists. This monitoring of employee and artists performance enables GAS staff to more efficiently distribute workloads.

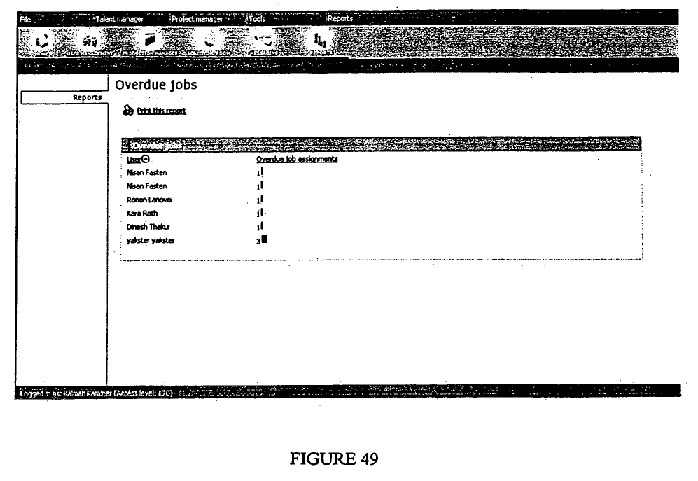

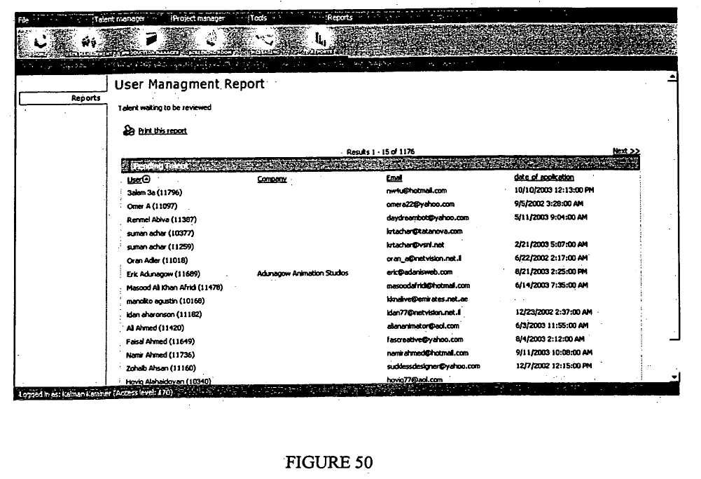

FIG. 49 illustrates a report of jobs. FIG. 50 illustrates a report of talent waiting to be reviewed. This is one non-limiting example of a user management report. Through this report, it is possible for GAS personnel to monitor the timeliness of review and artist rating.

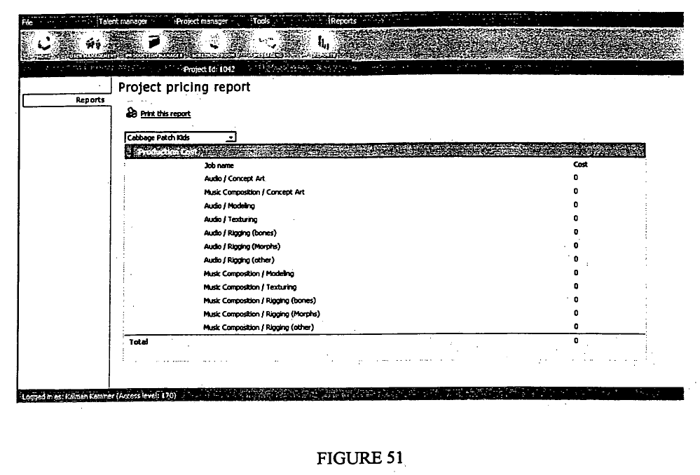

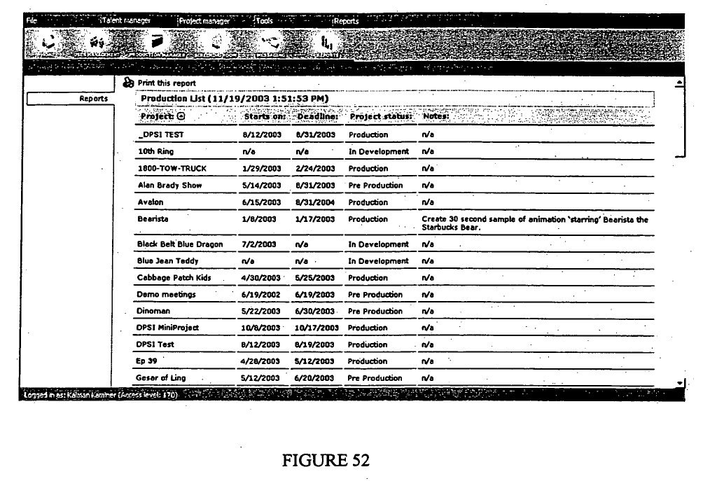

FIG. 51 illustrates the project pricing report, which is another important feature of the GAS. Through this report, it is possible for administration staff to easily view and determine costs and budget overruns. In the production list of FIG. 52, it is possible for GAS administration to review pending projects, start dates, deadlines, project status, and notes.

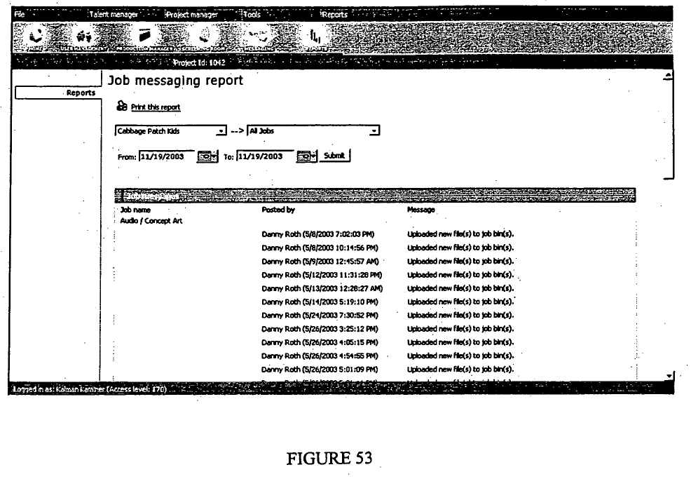

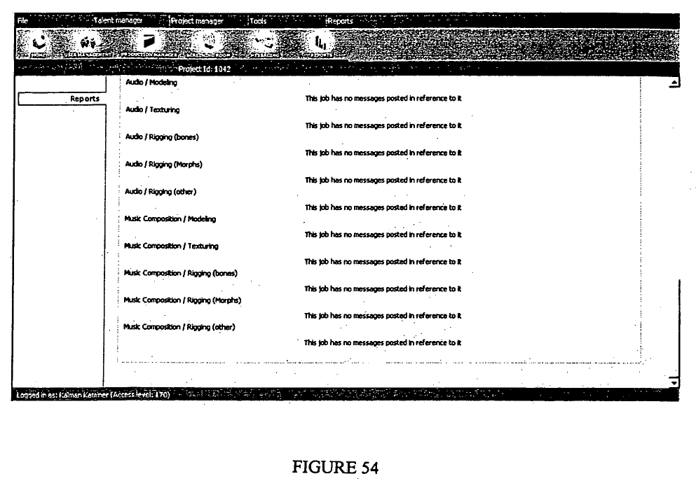

FIG. 53 is an example of a job messaging report. In the job messenger, it is possible to determine if any new information has been added to a job bin, for example. Through this screen, it is possible for a user to easily determine if certain parts of the project have recently been updated. FIG. 54 shows more details of the job report.

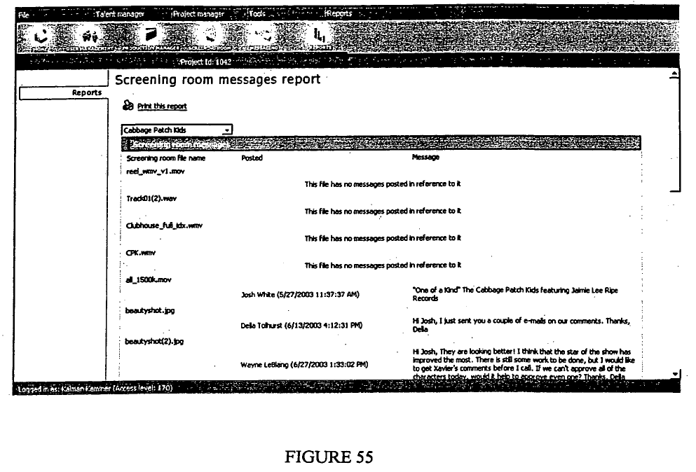

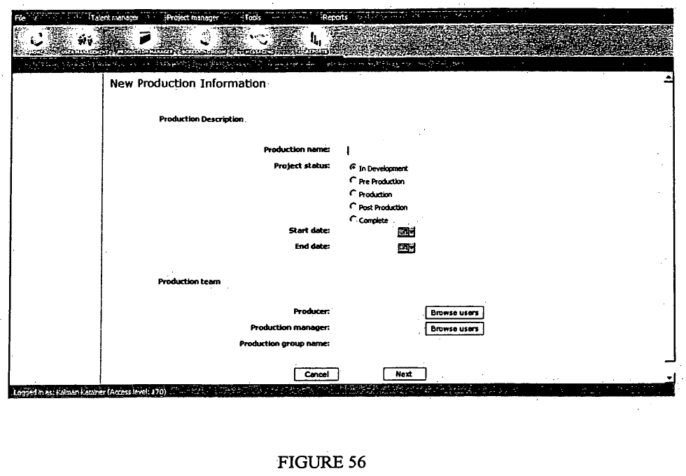

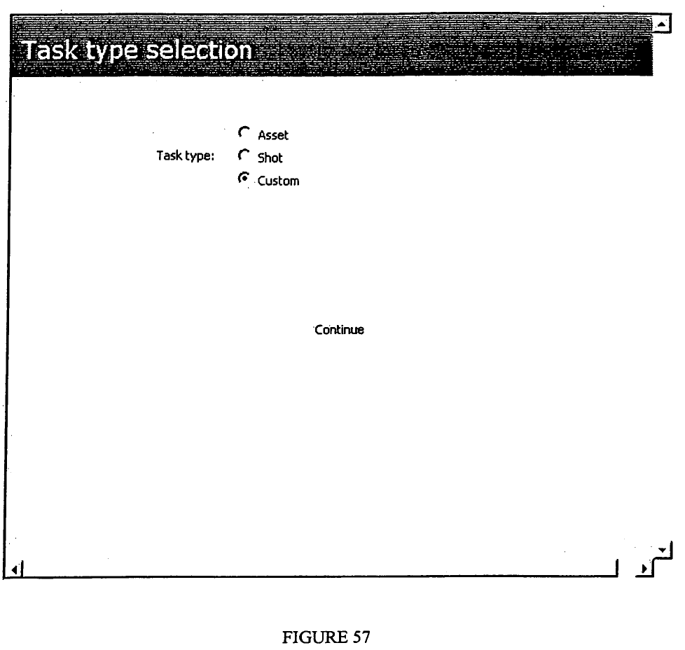

In the screening room messages report of FIG. 55, an administrator may easily view messages sent between users, to make sure that artists are receiving the appropriate feedback. FIG. 56 illustrates a new production information report. In this screen, it is possible for a GAS administrator to create a new production and fill in the necessary information. FIG. 57 illustrates a task type selection screen. In the example of FIG. 57, a custom task is being created.

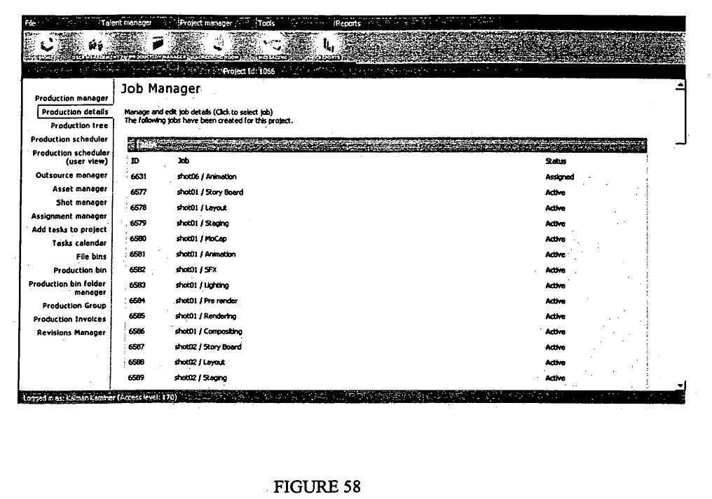

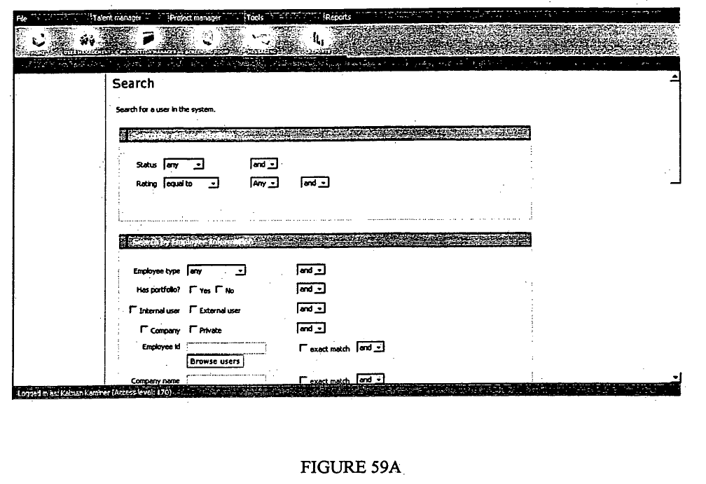

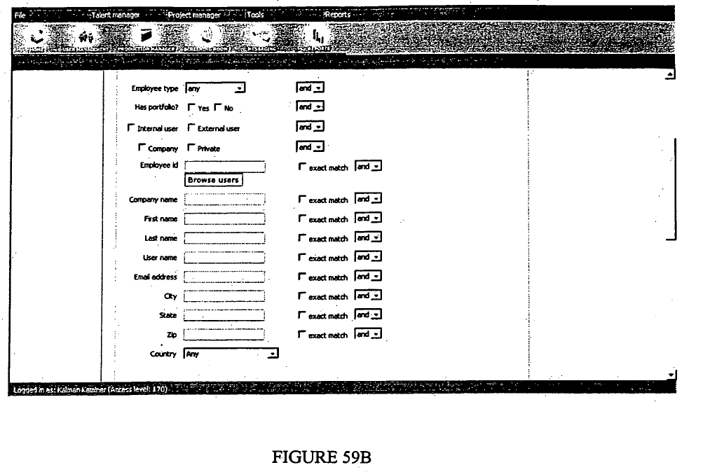

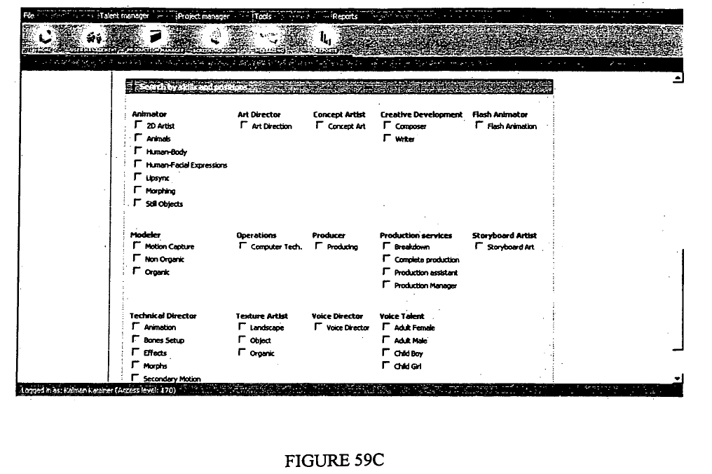

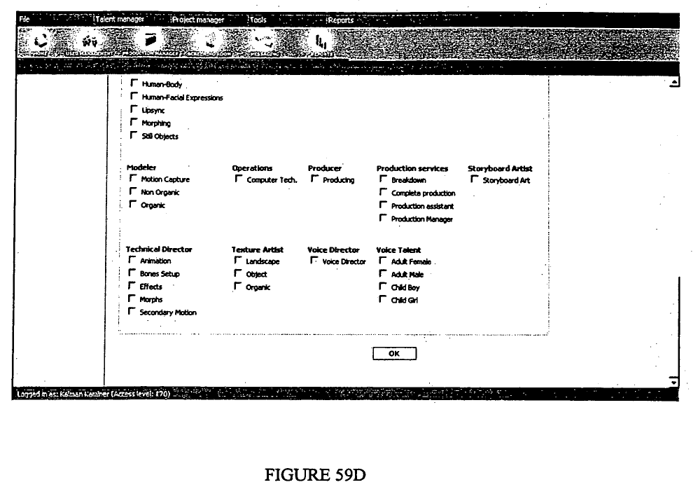

In the job manager of FIG. 58, an authorized GAS user may access the jobs displayed in the list. These jobs may be managed and edited. FIGS. 59A-59D illustrate the searchability of the GAS.

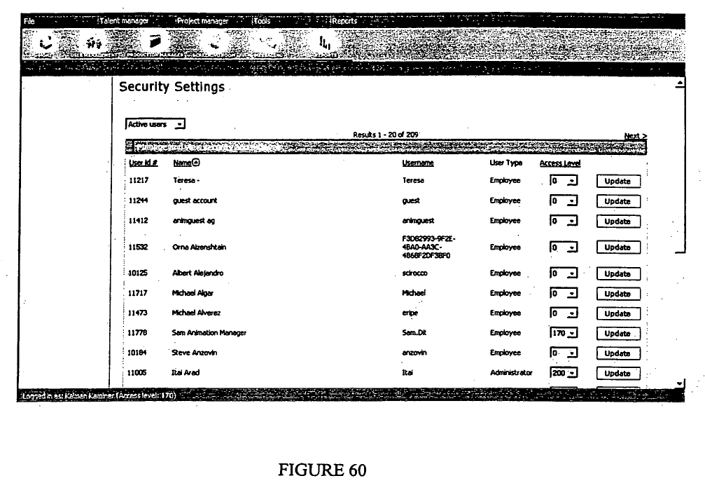

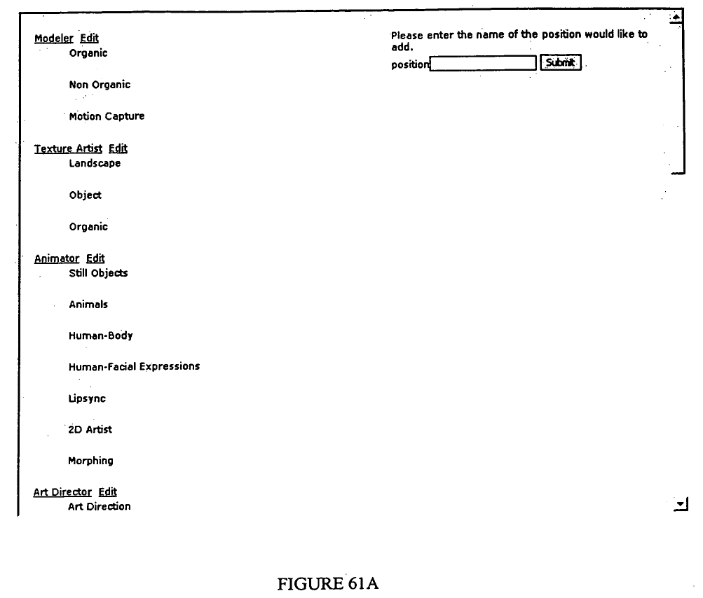

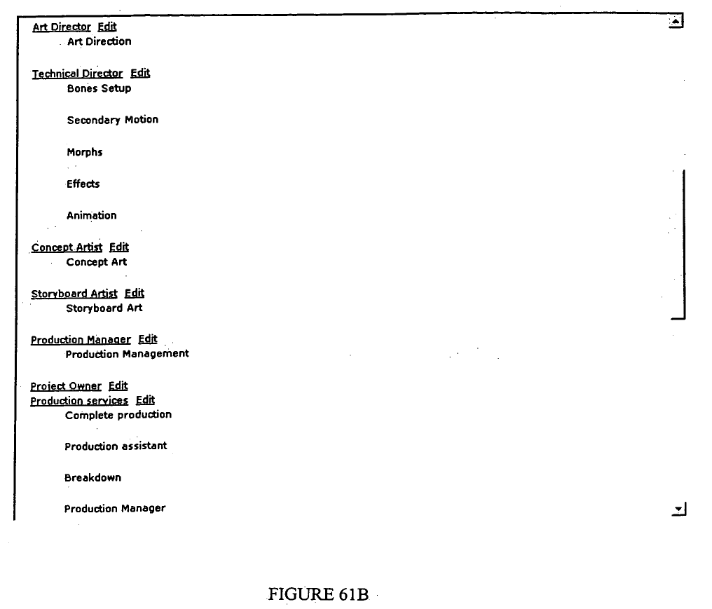

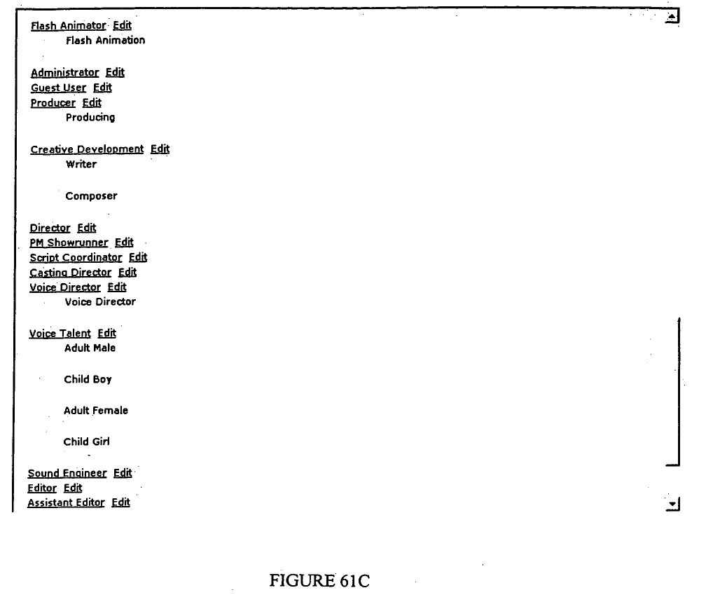

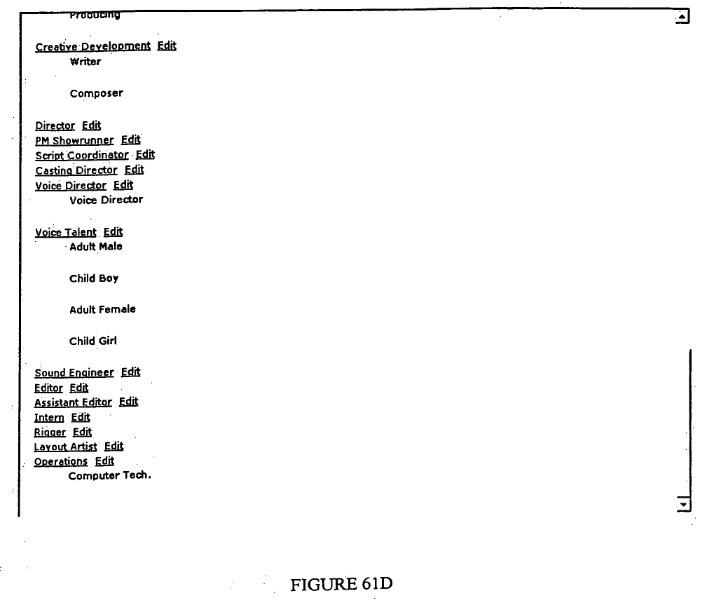

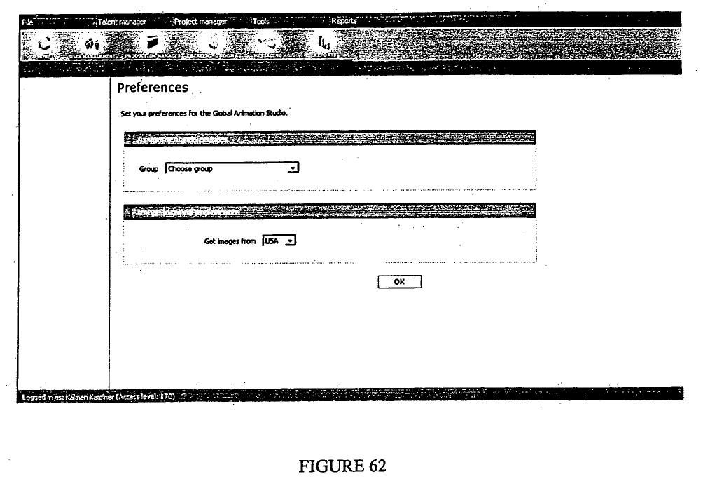

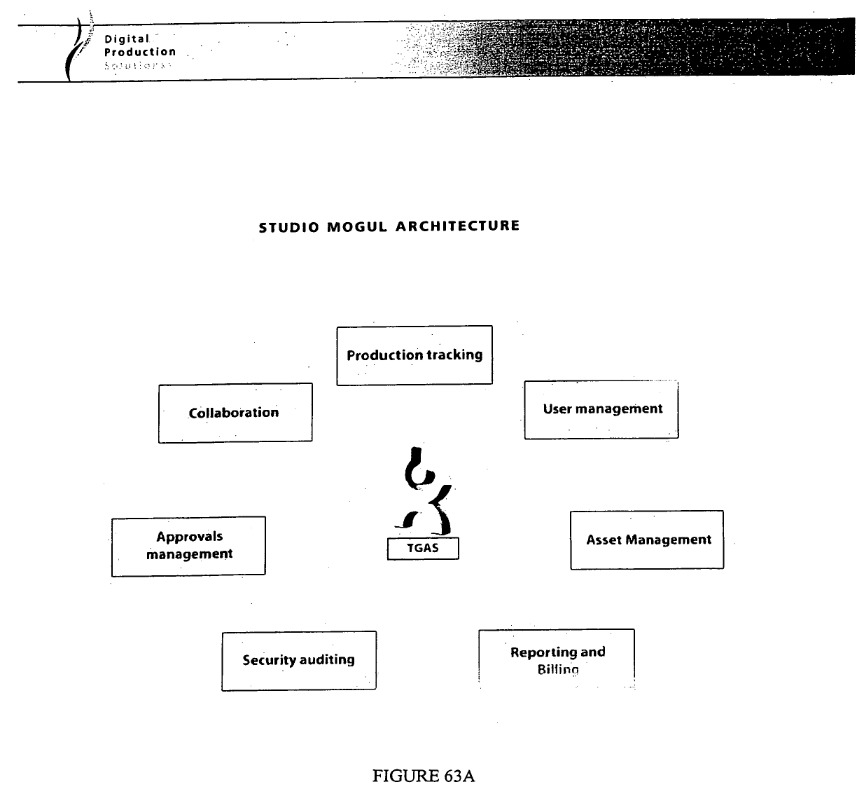

FIG. 60 illustrates some of the security settings of the GAS. In this screen, it is possible for a GAS administrator to modify the levels of access of each user. FIGS. 61A-61D illustrate setup of each person working on a project, as may be setup by a GAS administrator. FIG. 62 illustrates preferences that may be set by a GAS administrator.

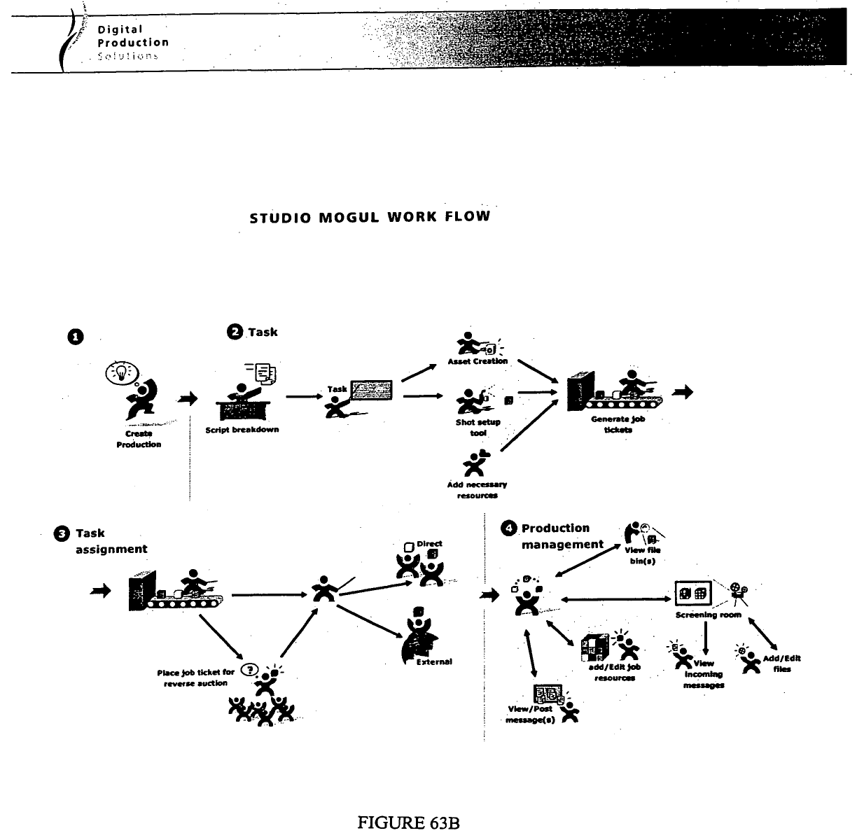

FIG. 63A shows a general overview of the studio mogul architecture. The features, as illustrated in FIG. 63A include production tracking, user management, asset management, reporting and billing control, security auditing, approval management, and collaboration ability, among others. FIG. 63B represents an overview of the studio mogul work flow. As illustrated in FIG. 63B, a production is created, including a script. Subsequently, script breakdown is performed. In the script breakdown, at least one assignable task is identified.

The tasks are then broken down to identify what assets and shots need to be created. Any necessary resources may be added to the system at this time. Once the assets and shots have been identified, job tickets may be generated.

Job tickets may be distributed in several ways. It is possible for artists to engage in a reverse auction for the task represented by the job ticket. Alternatively, the job ticket may be directly assigned to an in-house or remote affiliated artist.

In the production management stage, the assigned job tickets are monitored by GAS administration. The file bins are reviewed as necessary to monitor the artists' progress. Additionally, users access the screening room to view incoming messages and to add or edit files, as explained later. Additionally, users may post new messages, as explained below. GAS administrators may also add and/or edit job resources, as necessary.

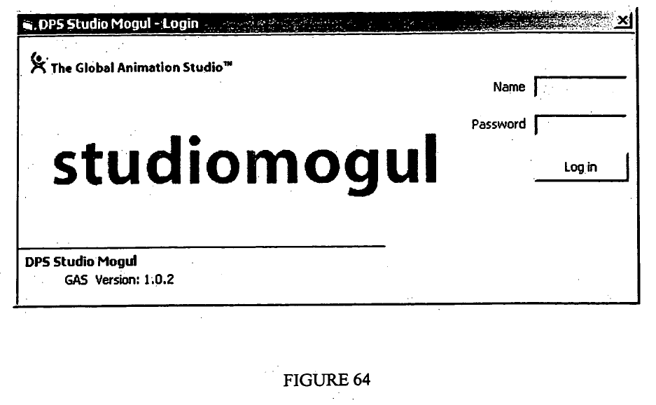

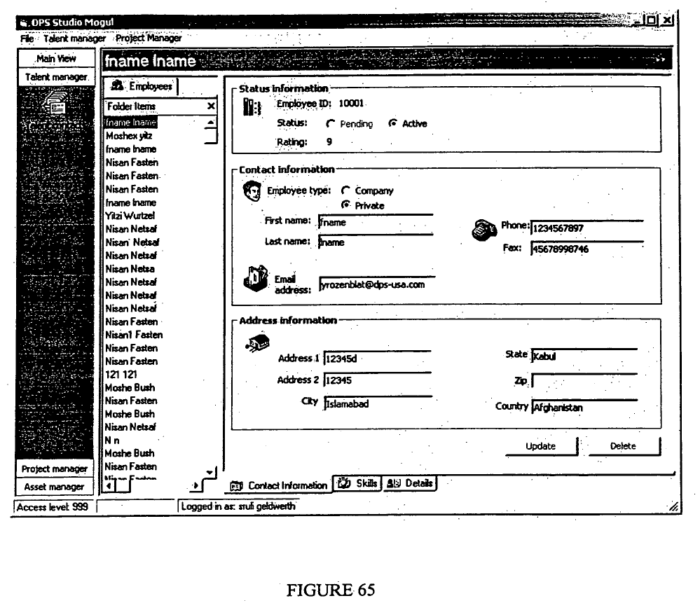

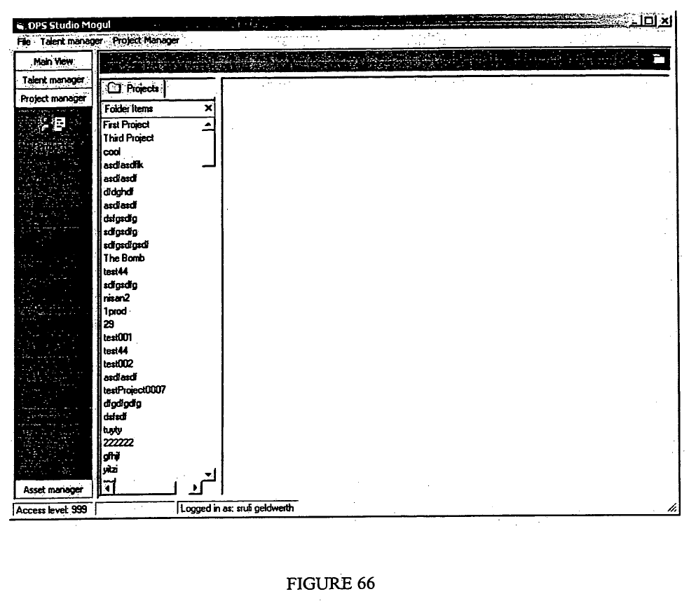

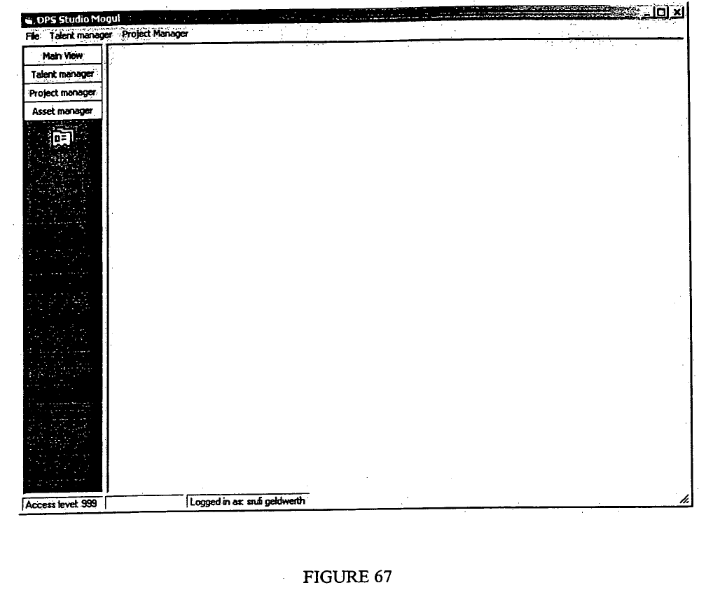

FIG. 64 illustrates the login screen for the studio mogul aspect of the GAS. In FIG. 65, the status information of each employee, the contact information, and the address information may be accessed and modified by GAS administration. The skill set and other details of each user may also be accessed. In the asset manager illustrated in FIG. 66, an authorized GAS administrator may access and modify projects listed in the projects folder. FIG. 67 illustrates when one such project is accessed. In the example of FIG. 67, no items have yet been created for that project.

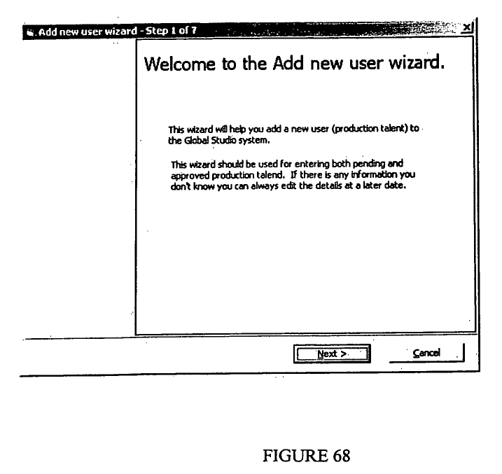

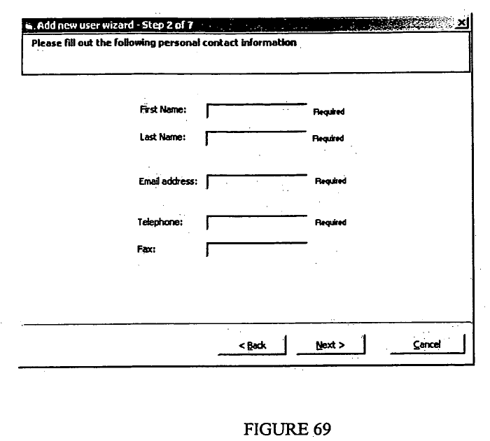

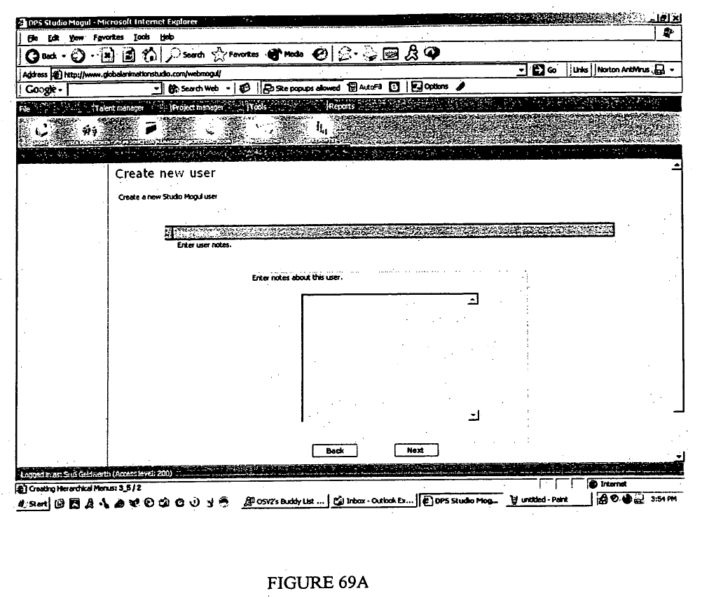

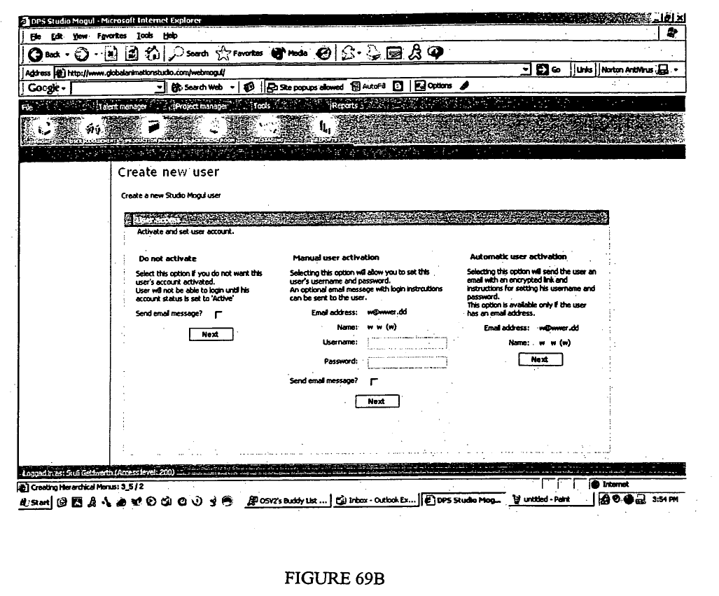

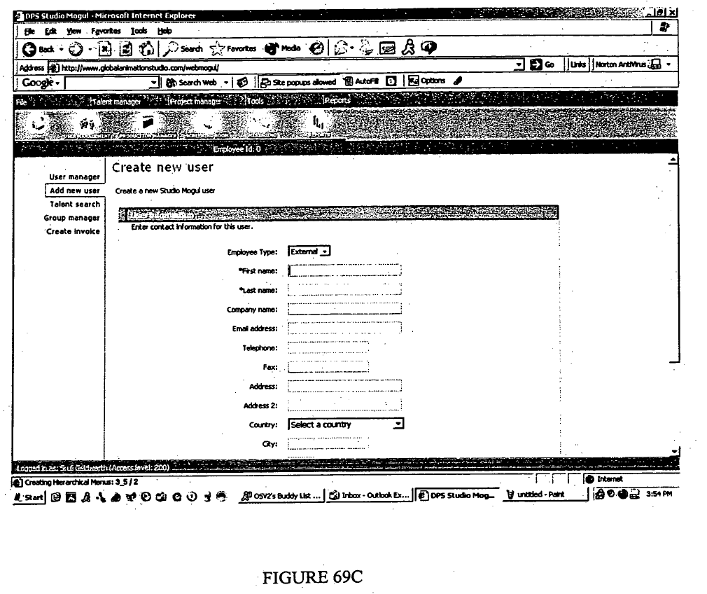

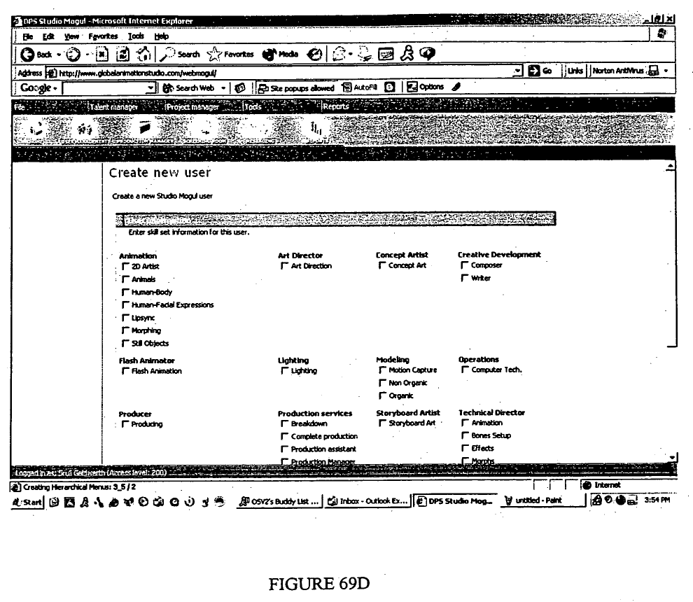

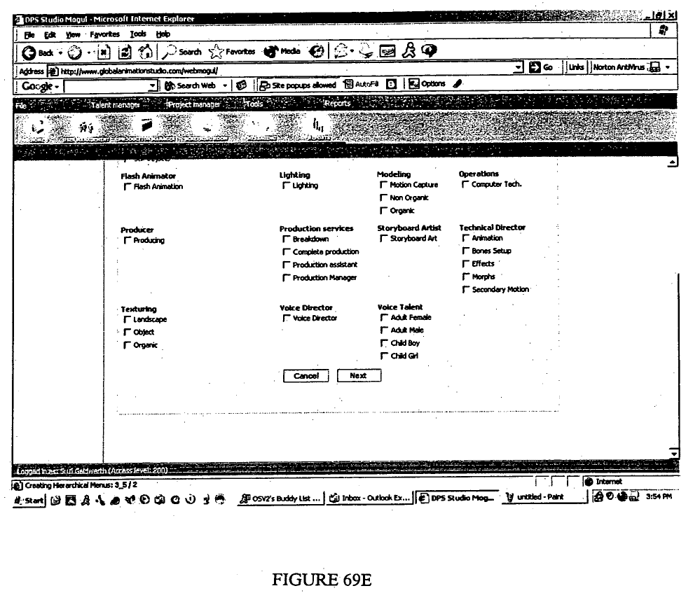

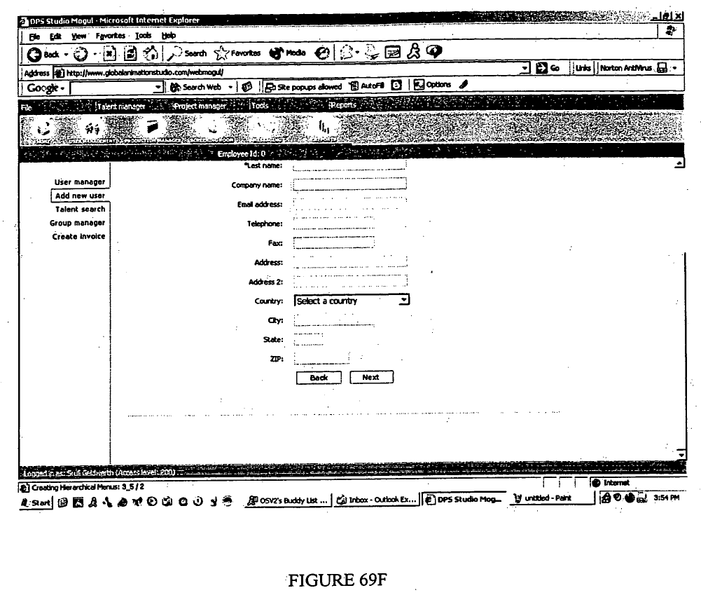

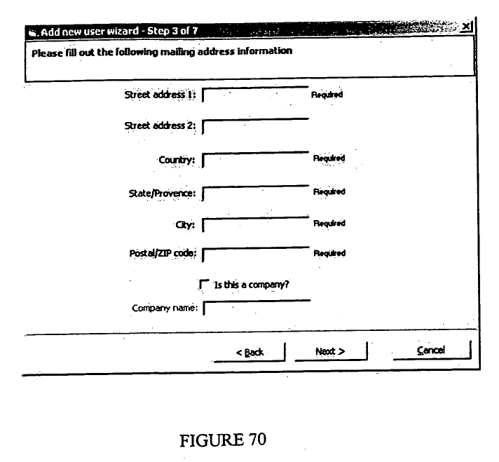

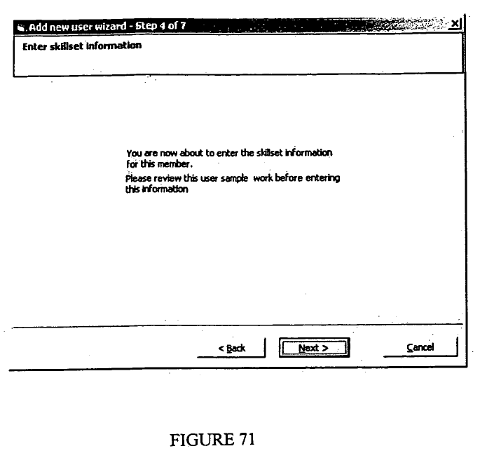

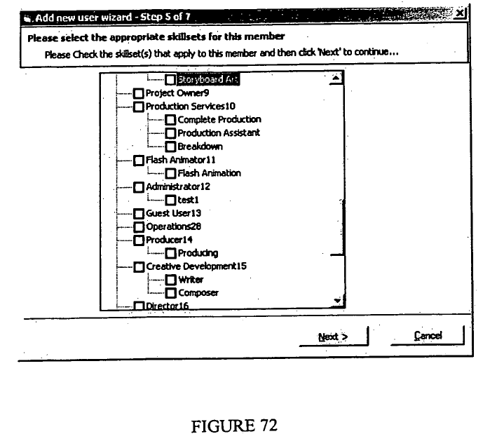

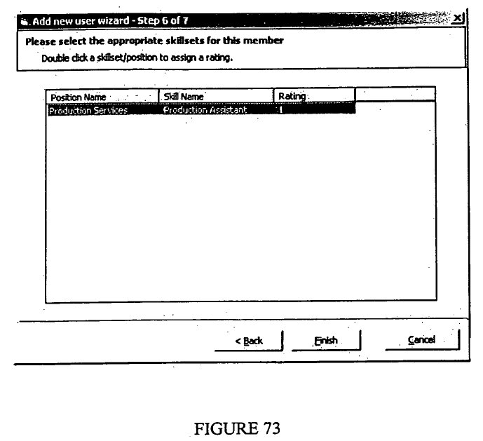

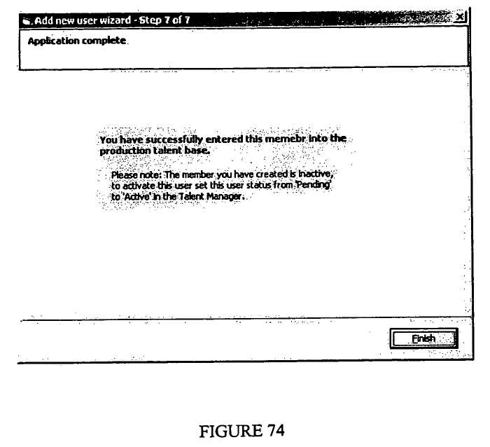

FIG. 68 illustrates the add a new user wizard of the studio mogul. As shown in FIG. 69, GAS personnel enters the first name, last name, and other relevant information for the user. FIGS. 69A-69F illustrate features of the studio mogul that may be initiated for the new user. FIG. 70 illustrates additional information to be entered about the user. In FIG. 71, the GAS administration is about to enter the skill set information, which requires that a sample be reviewed before the user's skill set is entered. FIG. 72 illustrates the skill sets that may be selected (as non-limiting examples) for each artist or employee. FIG. 73 illustrates a rating screen, where GAS personnel enter the skill level of the artist. FIG. 74 is a screen presented to the GAS administrator once the talent has been successfully entered into the production talent database.

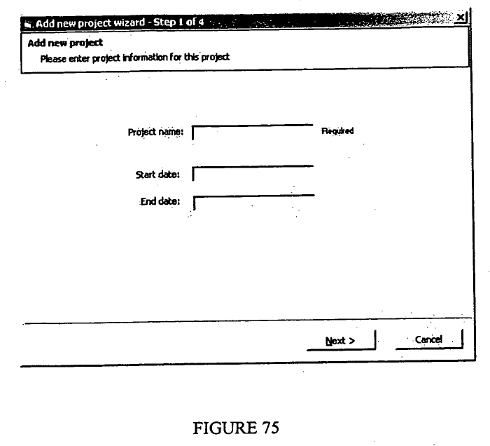

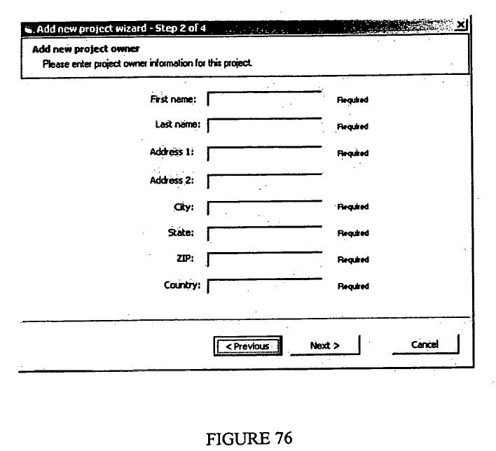

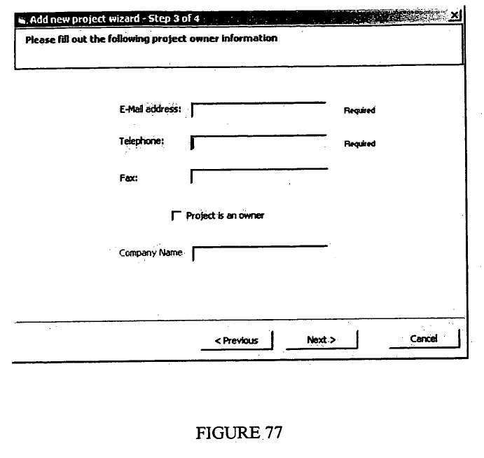

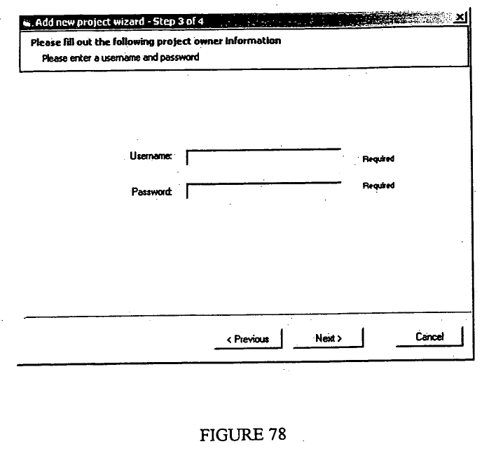

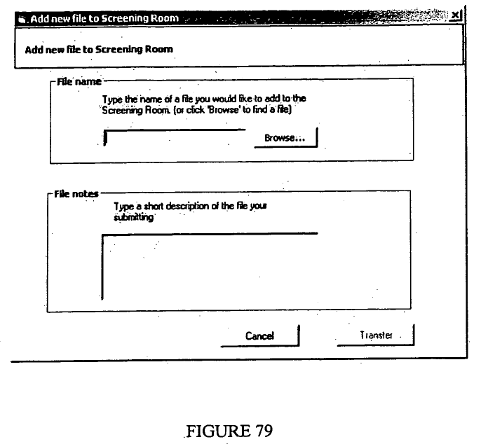

FIG. 75 illustrates a setup screen for a new project. In this setup screen, the user enters the project name, the start date, and the end date, for example. In FIG. 76, as phase 2 of the new project wizard, the GAS administrator enters project owner information (e.g., information about a client). FIG. 77 represents phase 3 of the new project wizard, where the GAS administrator enters additional project owner information. In FIG. 78, the GAS administrator creates a new user name and password. FIG. 79 illustrates a screen to create a file and file notes for use in the screening room.

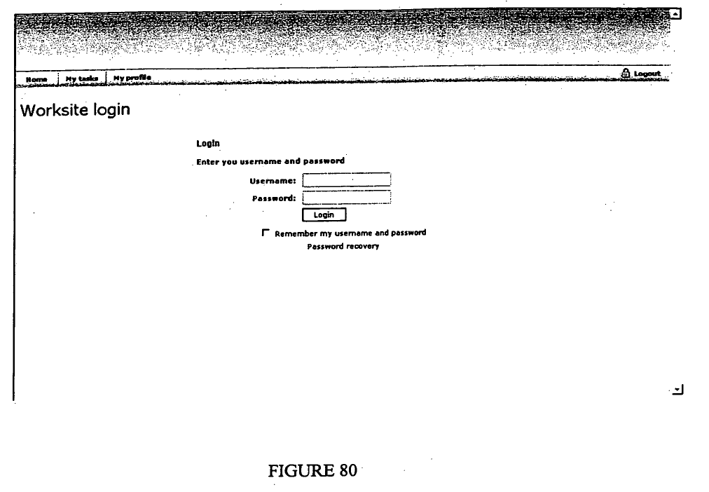

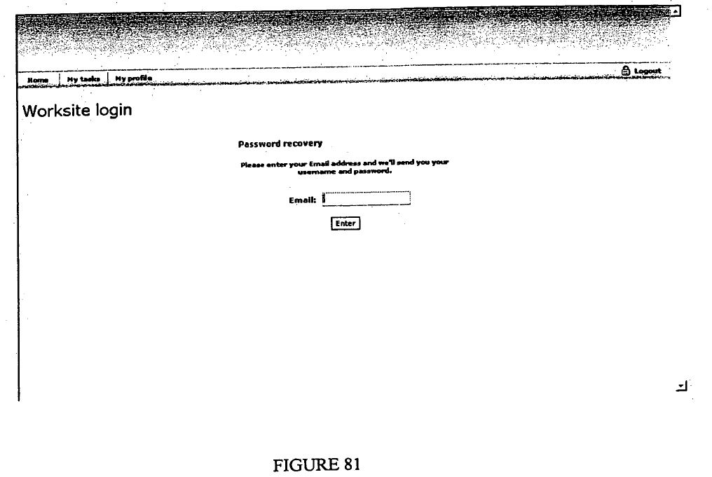

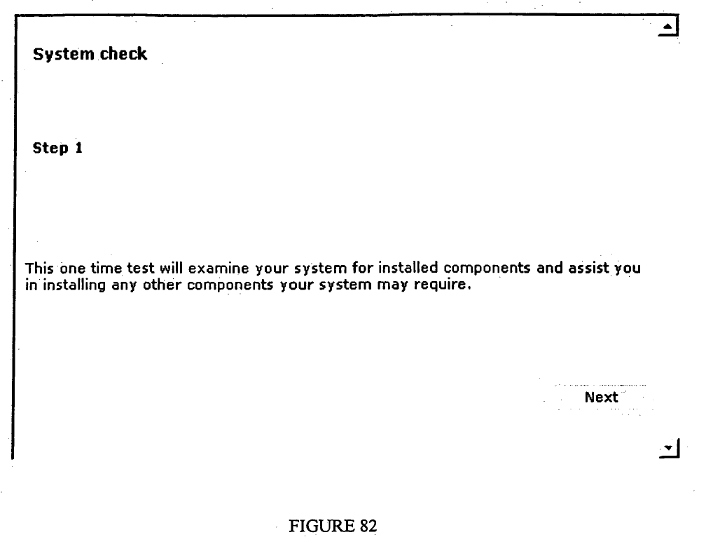

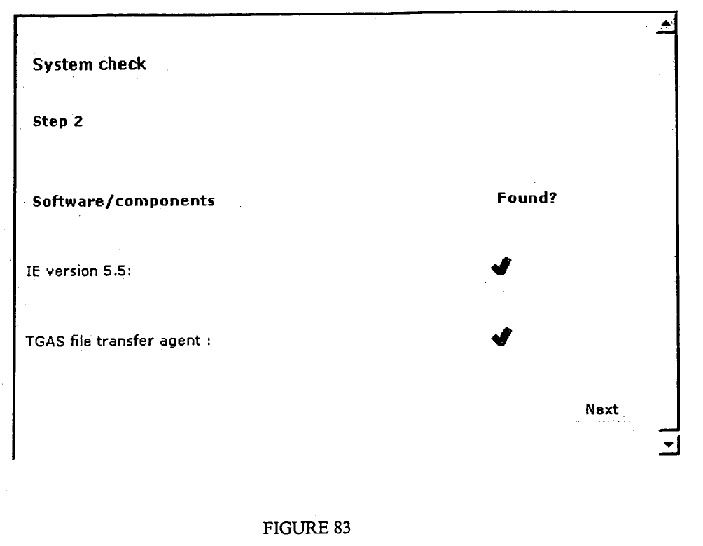

FIG. 80 illustrates a work site login. In the work site login, the user enters his username and password. FIG. 81 illustrates a password recovery screen that might be used by a user. FIGS. 80 and 81 correspond to login and password recovery for use in the screening room. In FIG. 82, the screening room runs a test to examine for components necessary for use in the screening room. FIG. 83 illustrates a successful search result.

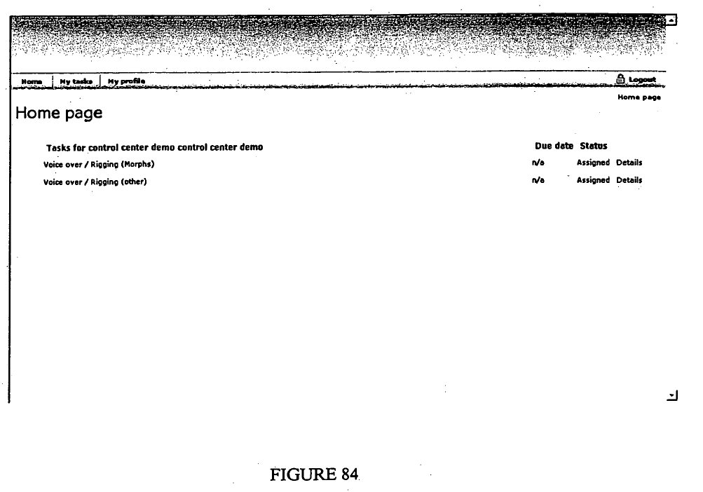

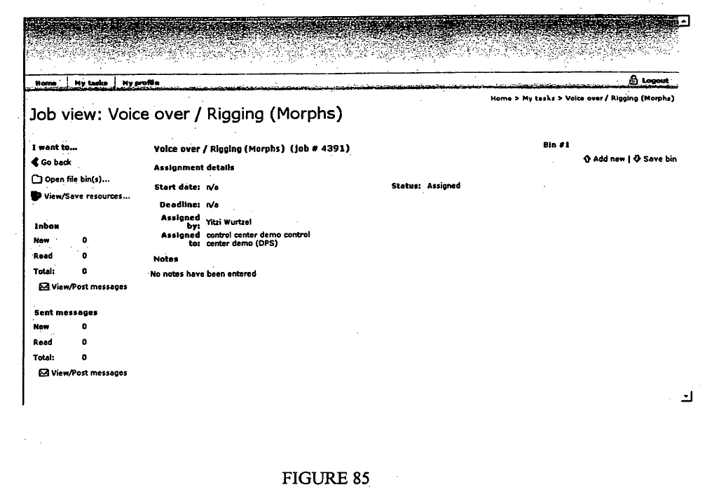

FIG. 84 illustrates a home page, which shows tasks for control center demo. These tasks may be displayed with relevant details. FIG. 85 illustrates the job view of the screening room. This particular job room relates to voiceover/rigging (morphs). This overview gives a general user of the GAS information about new and sent messages, as well as other details about each project.

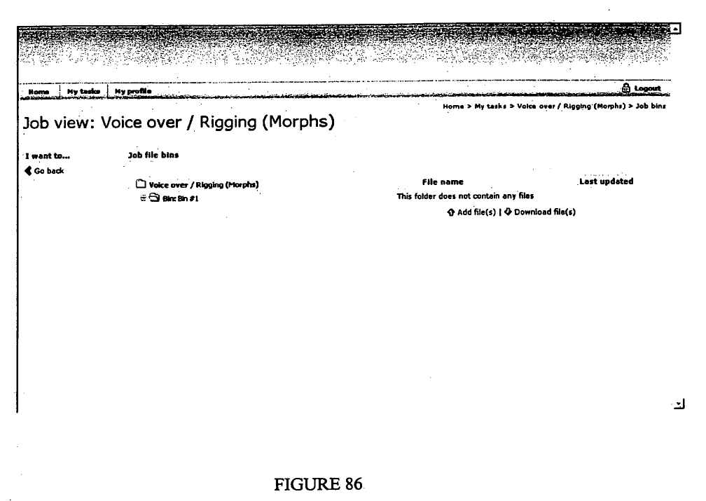

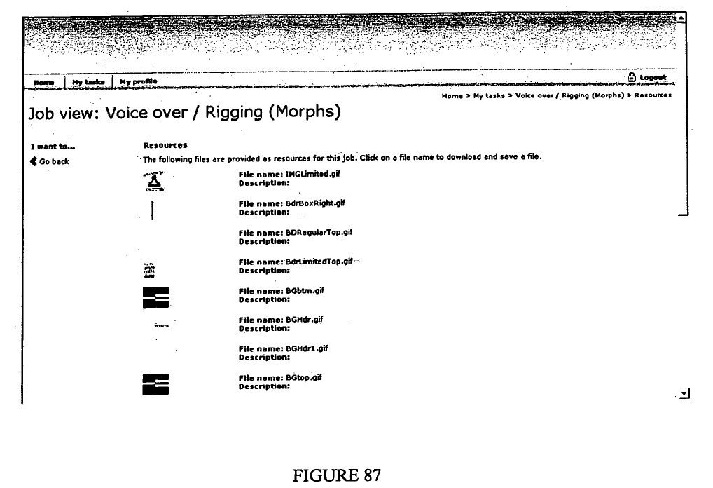

FIG. 86 illustrates when the node for the voiceover morph riggings is expanded to include details in one of the bins. In the non-limiting example of FIG. 86, no details are available for that file. FIG. 87 illustrates resources available for voiceover/rigging. In this example, several file names may be downloaded and saved by a user.

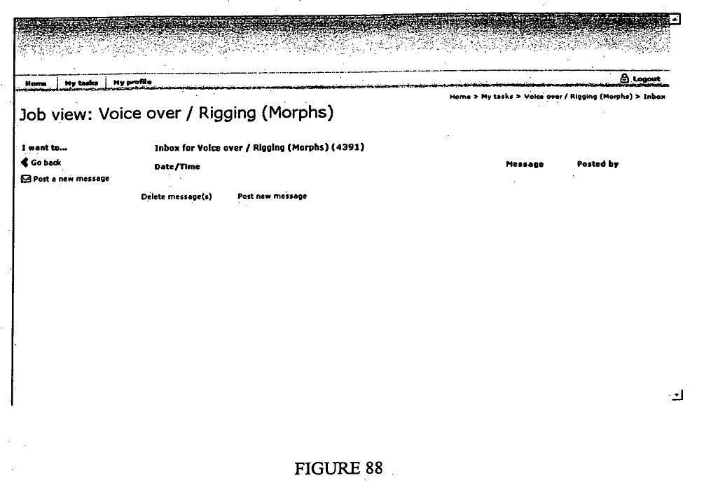

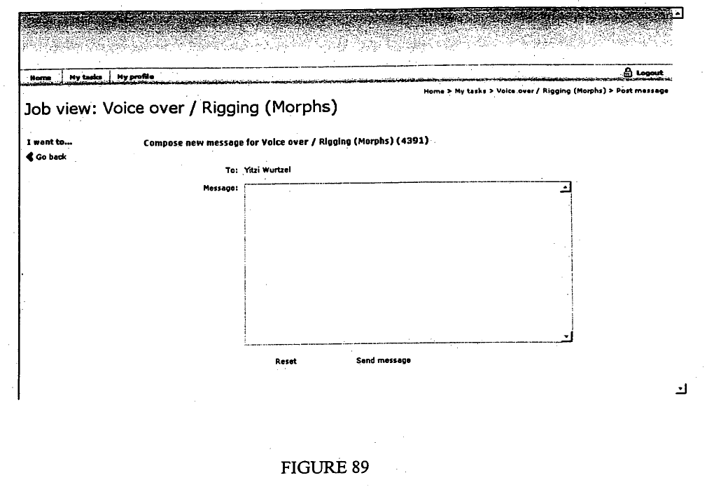

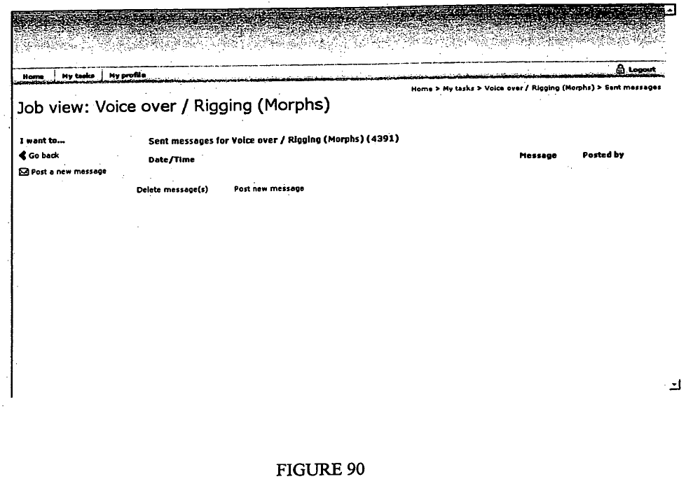

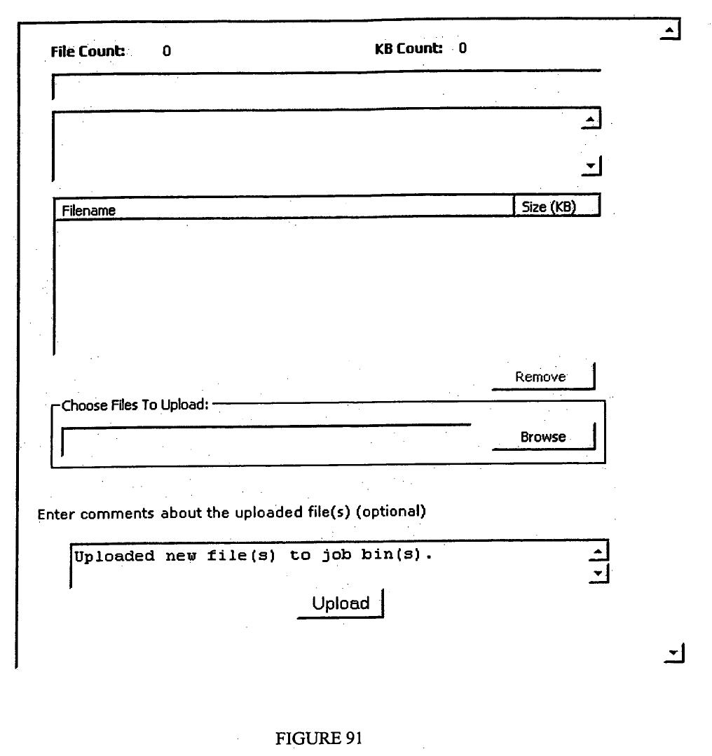

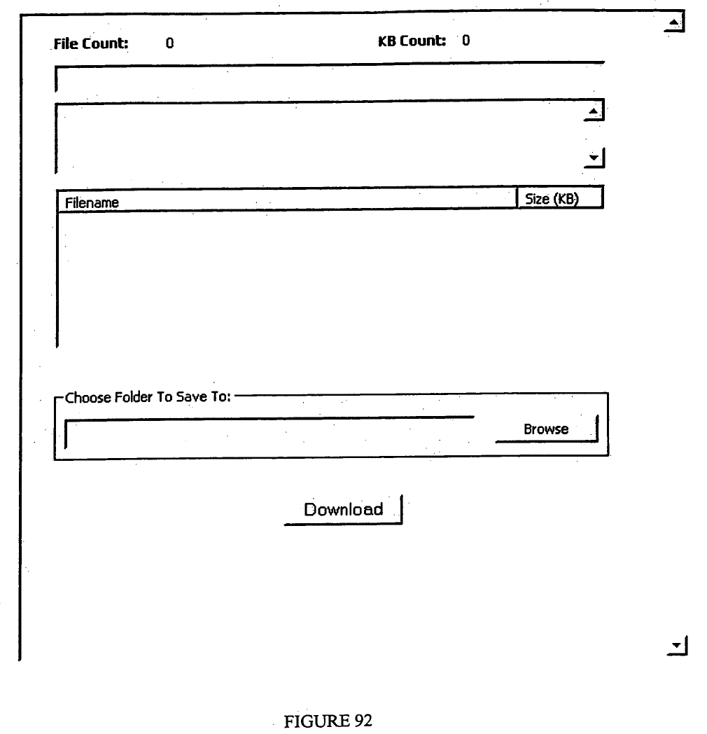

FIG. 88 illustrates how a GAS user may access messages, may delete messages, or may post a new message. FIG. 89 illustrates a screen that is presented to a GAS user when the user requests to create a new message. FIG. 90 illustrates the user's sent box, so that the user may access or delete previously sent messages. FIG. 91 illustrates a screen for a user to upload a file to the GAS. Specifically, a user may upload a file to a job bin, thereby creating, for example, one of the dailies to be reviewed by the GAS administration. FIG. 92 illustrates a download screen for a user, where a GAS user may choose to save a file to a local computer in a particular folder or location.

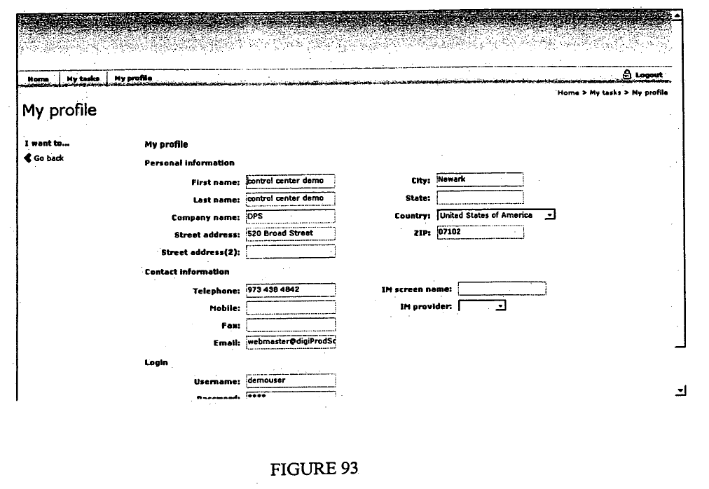

FIG. 93 illustrates how a user may edit his profile in the screening room. A screening room user may modify personal information, such as first name, last name, and address, as well as other features.

A computer may be used to implement the method of the present invention, wherein the computer housing houses a motherboard which contains a CPU, memory (e.g., DRAM, ROM, EPROM, EEPROM, SRAM, SDRAM, and Flash RAM), and other optical special purpose logic devices (e.g., ASICS) or configurable logic devices (e.g., GAL and reprogrammable FPGA). The computer may also include plural input devices, (e.g., keyboard and mouse), and a display card for controlling a monitor. Additionally, the computer may include a floppy disk drive; other removable media devices (e.g. compact disc, tape, and removable magneto optical media); and a hard disk or other fixed high density media drives, connected using an appropriate device bus (e.g., a SCSI bus, an Enhanced IDE bus, or an Ultra DMA bus). The computer may also include a compact disc reader, a compact disc reader/writer unit, or a compact disc jukebox, which may be connected to the same device bus or to another device bus.

Thus, it is evident that through the GAS, it is possible to more efficiently and easily manage global animation projects. Additionally, it is possible to easily allocate resources, assets, and common features for each user of the GAS. Due to the reusable features of the GAS, animation cost productions are decreased, and production time is reduced.

Obviously, numerous modifications and variations of the present invention are possible in light of the above teachings. It is therefore to be understood that within the scope of the appended claims, the invention may be practiced otherwise than as specifically described herein.

1. A global animation system, comprising:
a pool of reusable characteristics; and
a pool of available artists,
wherein a member of the pool of available artists selects at least one reusable characteristic from the pool of reusable characteristics to develop a character or feature.

2. The global animation system of claim 1, wherein the pool of reusable characteristics contains meta-data relating to the character or feature.

3. The global animation system of claim 2, wherein the meta-data includes at least one of a control button, a preset feature, a macro, and a computer program to control the at least one reusable characteristic.

4. The global animation system of claim 1, wherein the pool of reusable characteristics is developed at least in part by an administrator.

5. The global animation system of claim 1, wherein the pool of reusable characteristics is developed at least in part by at least one member of the pool of available artists.

6. The global animation system of claim 1, wherein each member of the pool of available artists is reviewed by an administrator prior to entry into the pool.

7. The global animation system of claim 1, wherein the member is selected based on at least one of a skill set, experience with a similar task, response time, cost, a national law, an international treaty, security, and a preference of a producer, director, or client.

8. The global animation system of claim 1, wherein the pool of reusable characteristics is configured to accept input to update the at least one reusable characteristic while the at least one reusable characteristic is in use.

9. The global animation system of claim 1, wherein the member may update the at least one character or feature in a pool of characters or in a pool of features.

10. The global animation system of claim 9, wherein an administrator may review the updated at least one character or feature prior to accepting the updated at least one character or feature.

11. The global animation system of claim 9, wherein the updated at least one character or feature is viewable by a customer.

12. The global animation system of claim 11, wherein the customer may post feedback viewable by at least one of the member and an administrator.

13. The global animation system of claim 12, further comprising a messager configured to notify at least one of the member and the administrator of the feedback.

14. A method for managing an animation project, comprising:
obtaining an animation project;
disassembling the animation project into at least one individual task;
assigning the at least one individual task to an artist,
wherein the artist completes the at least one individual task using at least one characteristic stored in a pool of reusable characteristics.

15. The method of claim 14, wherein the assigning step is based on at least one of a skill set, experience with a similar task, response time, cost, a national law, an international treaty, security, and a preference of a producer, director, or client.

16. The method of claim 14, wherein the pool of reusable characteristics contains meta-data relating to at least one character or feature of an animation project.

17. The method of claim 16, wherein the meta-data includes at least one of a control button, a preset feature, a macro, and a computer program to control the at least one reusable characteristic.

18. The method of claim 14, wherein the pool of reusable characteristics is developed at least in part by an administrator.

19. The method of claim 14, wherein the pool of reusable characteristics is developed at least in part by the artist.

20. The method of claim 14, wherein the artist is a member of a pool of available artists and each member of the pool of available artists is reviewed by an administrator prior to entry into the pool.

21. The global animation system of claim 14, wherein the pool of reusable characteristics is configured to accept input to update the at least one reusable characteristic while the at least one reusable characteristic is in use.

22. The global animation system of claim 14, wherein the member may update the at least one character or feature in a pool of characters or in a pool of features.

23. The global animation system of claim 22, wherein an administrator may review the updated at least one character or feature prior to accepting the updated at least one character or feature.

24. The global animation system of claim 22, wherein the updated at least one character or feature is viewable by a customer.

25. The global animation system of claim 24, wherein the customer may post feedback viewable by at least one of the artist and an administrator.

26. The global animation system of claim 25, further comprising a messager configured to notify at least one of the artist and the administrator of the feedback.

27. A method for searching for reusable characteristics, comprising:
searching a pool of reusable characteristics for at least one first characteristic;
identifying at least one second characteristic related to the at least one first characteristic;
notifying a user of the at least one second characteristic;
locating a file containing the at least one second characteristic; and
providing the file.

28. The method of claim 27, wherein the pool of reusable characteristics is created at least in part by an administrator.

29. The method of claim 27, wherein the pool of reusable characteristics is created at least in part by an artist.

30. The method of claim 29, wherein the artist is a member of a pool of available artists.

31. The method of claim 27, wherein the identifying is based on at least one of a first identifier associated with the at least one first characteristic and a second identifier associated with the at least one second characteristic.

32. The method of claim 27, wherein the pool of reusable characteristics is configured to accept input to update the at least one reusable characteristic while the at least one reusable characteristic is in use.

33. A system for searching for reusable characteristics, comprising:
means for searching a pool of reusable characteristics for at least one first characteristic;
means for identifying at least one second characteristic related to the at least one first characteristic;
means for notifying a user of the at least one second characteristic;
means for locating a file containing the at least one second characteristic; and
means for providing the file.

34. The apparatus of claim 33, wherein the pool of reusable characteristics is created at least in part by an administrator.

35. The apparatus of claim 33, wherein the pool of reusable characteristics is created at least in part by an artist.

36. The apparatus of claim 35, wherein the artist is a member of a pool of available artists.

37. The apparatus of claim 33, wherein the means for identifying uses at least one of a first identifier associated with the at least one first characteristic and a second identifier associated with the at least one second characteristic.

38. The apparatus of claim 33, wherein the pool of reusable characteristics is configured to accept input to update the at least one first or second reusable characteristic while the at least one first or second reusable characteristic is in use.
